(19) United States
(12) Patent Application Publication
(10) Pub. No.: US 2015/0112749 A1
(43) Pub. Date: Apr. 23, 2015

(54) METHOD AND SYSTEM FOR PROCESSING ACTIONABLE MESSAGES OF AN INTEGRATED COMMUNICATION AND COLLABORATION PLATFORM

(71) Applicant: Abdullah Celik Erdal, Santa Cruz, CA (US)

(72) Inventor: Abdullah Celik Erdal, Santa Cruz, CA (US)

(21) Appl. No.: 14/521,100

(22) Filed: Oct. 22, 2014

Related U.S. Application Data
(60) Provisional application No. 61/894,402, filed on Oct. 22, 2013.

(51) Int. Cl. G06F 3/0484; H04L 12/58; G06Q 10/10; G06F 3/0481

(52) U.S. Cl. CPC G06F 3/04847; G06F 3/0481; G06F 3/04842; H04L 51/04; G06Q 10/1095; G06Q 10/107
USPC 705/7.19; 715/752

(57) ABSTRACT

According to one embodiment, a sender can compose an actionable message in an integrated communication and collaboration platform. The actionable message includes an action to be performed by a recipient. The action can be a task or a meeting event that requires the recipient to do something. The sender can specify in an actionable message a due date by which the action to be performed, a reply-by date by which the recipient has to acknowledge (e.g., accept, decline), and an optional duration that estimate amount of time to perform such an action. If the action is an event, the sender can also specify recipient(s) who must attend, recipient(s) who should attend, and optional FYI recipient(s) who only receive the message as an FYI message. When the actionable message is received by the recipient, the message is displayed in a dedicated folder separated from the regular messages without an action.

### RELATED APPLICATIONS

This application claims the benefit of U.S. Provisional Patent Application No. 61/894,402, filed Oct. 22, 2013, which is incorporated by reference herein in its entirety.

### FIELD OF THE INVENTION

Embodiments of the present invention relate generally to enterprise software. More particularly, embodiments of the invention relate to an integrated workplace management platform.

### BACKGROUND

Email is and has been for decades the mission critical communication and collaboration tool businesses are utilizing today. Some research firms expect that, over the next four years, corporate email accounts to increase at a faster pace than consumer email accounts. This will be particularly due to the growth of affordable cloud-based email services. Every day, over billions of corporate emails sent around the world, and knowledge workers handle a large amount of email messages every day.

However, the cost of this freedom is, anyone who knows your email address can send you one. Current email is a push technology, i.e., the sender controls who receives the message. The consequence is information overload that costs the U.S. economy billions every year, lowers employee productivity and reduced innovation. Users typically have to go through many emails to find the ones that are important, and then take action. In addition, free format of email text messages are not ideal for understanding what the sender really asking for and what the recipient is supposed to do. Business can benefit from a new email messaging protocol that allows separating actionable emails, critical work activities from all other non-important emails and messages.

Current email tools are based on archaic protocols with very limited capabilities, and do not give much control to end users, resulting in excessive productivity loss in the work place. For example, knowledge workers spend about 2½ hours of their workday using their email. However, only 1 in 7 of these daily emails received are characterized as critical to work activities. Therefore, a typical knowledge worker end up wasting substantial amount of their time for searching and sorting emails and relevant information. Many of those unrelated or unnecessary emails not only create distraction but also unmanageable information overload for the knowledge workers. According to research, 80% of the emails in our inbox are not important or urgent, leaving only 20% of the emails to be perhaps critical to our business.

Current email tools and other disparate point tool approaches are not enough to remedy the enormous pain businesses are experiencing today. As a result, businesses are in desperate and urgent need for new and better solutions to enable knowledge workers to manage the information overload and get the job done efficiently and effectively.

Within the past several years, social media and networking became popular way of communicating and collaborating, especially for individuals through, for example blogs, microblogs, twits, chats, and other. However, many of these point tools are facing adaption problems within business, because these tools cannot solve all the needs of business today. Furthermore, integration and communication between these relatively new social tools and existing email tools either minimal or does not exist.

Businesses can benefit from integration between email calendar, task management, TODO, project management tools as well as social networking solutions such as blogs, forums, wikis, etc. to address their communication and collaboration needs. Integration of the right point tools help resolve many of these problems listed above. The challenge is how to integrate all these tools while providing a simple, easy to use and secure communication environment, while improving employee productivity, performance and execution.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating architecture of an integrated communication and collaboration system according to one embodiment of the invention.

FIGS. 2A-2B are block diagrams illustrating architecture of an integrated communication and collaboration system according to some embodiments of the invention.

FIGS. 3A-3C show diagrams of an example of a system for generating and managing work activities that include events according to some embodiments.

FIG. 4 illustrates a diagram of a flowchart of an example method for generating and managing work activities according to one embodiment.

FIG. 5 is a block diagram illustrating an example of an integrated communication and collaboration system according to one embodiment of the invention.

FIG. 6A is a block diagram illustrating a conventional data structure.

FIG. 6B is a block diagram illustrating an actionable message data structure according to one embodiment of the invention.

FIGS. 7A and 7B are processing flows of actionable messages according some embodiments of the invention.

FIGS. 8A and 8B are block diagrams illustrating certain data structures of actionable messages according to some embodiments of the invention.

FIGS. 9A-9C are processing flows of actionable messages according some embodiments of the invention.

FIGS. 10A-10C are diagrams illustrating dependency relationships of data entities according to some embodiments of the invention.

FIG. 11 is a processing diagram illustrating processing actionable messages according to one embodiment of the invention.

FIG. 12 is a processing diagram illustrating processing actionable messages according to another embodiment of the invention.

FIG. 13 is a processing diagram illustrating processing actionable messages according to another embodiment of the invention.

FIG. 14 is a processing diagram illustrating processing actionable messages according to another embodiment of the invention.

FIG. 15 is a processing diagram illustrating processing actionable messages according to another embodiment of the invention.

FIG. 16 is a processing diagram illustrating processing actionable messages according to another embodiment of the invention.

FIGS. 17A-17F are screenshots illustrating examples of graphical user interfaces of an integrated communication and collaboration platform according to some embodiments of the invention.

FIGS. 18A-18D are screenshots illustrating examples of graphical user interfaces of an integrated communication and collaboration platform according to some embodiments of the invention.

FIGS. 19A-19G are screenshots illustrating examples of graphical user interfaces of an integrated communication and collaboration platform according to some embodiments of the invention.

FIGS. 20A-20E are screenshots illustrating examples of graphical user interfaces of an integrated communication and collaboration platform according to some embodiments of the invention.

FIG. 21 is a block diagram illustrating an example of a data processing system which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

An integrated communication and collaboration platform and system is described herein. The integrated communication and collaboration platform not only addresses the above needs, but also provides additional unique features to improve their communication and collaboration among people, and improves workforce productivity, performance and improve execution. The integrated communication and collaboration platform simplifies decision-making by giving people the whole picture, including transparency, real-time visibility, and insight into all activities, projects and tasks. The communication and collaboration core technology enables business to align their workforce around organization's goals and priorities. The integrated communication and collaboration platform offers a seamless alternative to numerous disconnected point-tools that businesses use today, like email, calendar, project management, task management, activity streams, chat, workflow, notes, TODOs and complements and extends existing legacy systems such as ERP (enterprise resource planning), EPM (enterprise project management), HCM (human capital management), and HR (human resources) systems,

According to some embodiments, a user, as a work activity creator, or sender, can compose an actionable message (e.g., an actionable email) using a graphical user interface (GUI) of an integrated communication and collaboration platform (also referred to as a workplace management platform) that includes an action (also referred to as a work activity or WA) to be performed by another user or recipient, as a work activity participant. The action specified in the actionable message can be a task, a meeting event, or some other activities that require the recipient to do something. The sender can specify in an actionable message a due date by which the action to be performed, a reply-by date by which the recipient has to acknowledge (e.g., accept, decline, or request for change or RFC), and an optional duration that estimate amount of time to perform such a task. If the action is an event or meeting invitation, according to one embodiment, the sender can also specify recipient(s) who are required to attend, recipient(s) who should attend, and optional FYI recipient(s) who only receive the message as an FYI message.

According to one embodiment, when composing an actionable message, the sender can also determine whether the intended recipient has enough bandwidth to perform such an action based on the reply-by date, due date, and duration of the action. For example, once the sender specifies the recipient, the reply-by date, due date, and duration of the action, the calendar manager may automatically access the calendar of the recipient(s) to determine the availability of the intended recipient based on the reply-by date, due date, and duration of the action. An alert or warning may be sent or displayed to the sender if it is determined that the recipient(s) may not have the necessary bandwidth to perform the task.

When a recipient receives such an actionable message, an action manager or event manager of the system automatically detects this is an actionable message with an action associated with therein that distinguishes from an ordinary message without requiring or asking the recipient to do something. An ordinary message is referred to as a regular message or for-your-information or FYI message. According to one embodiment, the system places or stores the actionable messages in a dedicated folder (e.g., “Act Now” folder or panel) while storing the regular messages in another folder (e.g., regular inbox). As a result, the recipient can easily identify or determine whether there is an actionable message having a pending or outstanding activity that requires his or her attention. In addition, according to one embodiment, a scheduler or calendar may automatically set up a reminder or alert to remind the recipient to respond to the actionable message. For example, a reminder or alert may be triggered prior to the reply-by date of the actionable message so that the recipient can respond, for example, accepting, declining, or requesting for change. If the recipient decides to request for a change of the action, the integrated platform provides a user friendly GUI to allow the recipient and the sender to have a real-time communication session (e.g., chat, voice) to discuss the potential change right from the actionable message in question.

According to one embodiment, once a recipient accepts the action, the calendar manager can display within the integrated environment a calendar GUI to allow the recipient to schedule the action. In addition, the calendar manager may further determine and display one or more available time slots of the recipient based on the reply-by date, due date, and/or duration of the action. If the action requires multiple participants or recipients (e.g., a meeting or event that requires members of a team or group associated with a particular project or department of an organization), the calendar manager may display the available time slots for all of the participants, such that each participant can view the availability information of other participants. The participants can also conduct an in-line (e.g., while in the calendar GUI) communication session, such as a chat session, to discuss or propose an agreed-upon time slot. A participant can drag and drop an available time slot into a particular cell (e.g., particular date) of the calendar view. In response, the calendar manager automatically schedules the action in the calendar database or entry associated with that particular participant.

According to another embodiment, once a recipient of an actionable message accepts the action, he or she can reassign or delegate the action to another user or users. In doing so, a second actionable message may be derived from the original or first actionable message, having the same action or event embedded therein. The second actionable message is then sent to the delegated user(s), i.e., delegatee(s). The delegator may specify the same or different reply-by date, due date, or duration in the second actionable message. A delegator and a delegatee can also exchange messages regarding acceptance, rejection, or RFC of the second actionable message. In one embodiment, the scheduling of the action may be performed automatically according to a set of rules associated with the participant, manually, or in a user guided manner.

According to another embodiment, when a calendar view is displayed, there are at least two scroll buttons for each of the backward and forward directions displayed to scroll the calendar view at different paces or sizes of steps. The first button, which when activated, causes the calendar view to scroll based on the calendar view currently displayed. For example, if the calendar is in a daily, weekly, or monthly view, the first button causes the calendar view to scroll by a day, a week, or a month, respectively. The second button, which when activated, causes the calendar view to scroll in a predetermined step, e.g., only a day at a time, regardless the current calendar view configuration.

According to a further embodiment, a user can also conduct a collaboration session, such as a meeting or conferencing, with multiple participants within the GUI of the integrated communication and collaboration platform. The meeting GUI includes a first display area to display the presentation content shared with the participants and a second display area to display metadata of the meeting that is associated with that particular participant, which may or may not be shared with other participants. The second display area includes multiple tabs or pages including, but are not limited to, meeting agendas, meeting details, tasks associated with the meeting, attendees, and meeting minutes. A participant can select any of the tabs or pages to display the associated information in the second display area, while the shared presentation is displayed in the first display area.

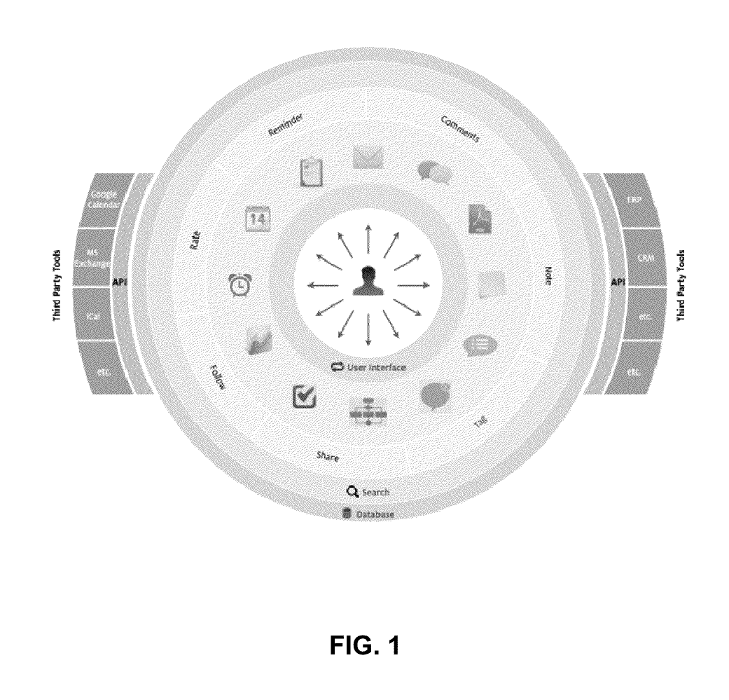

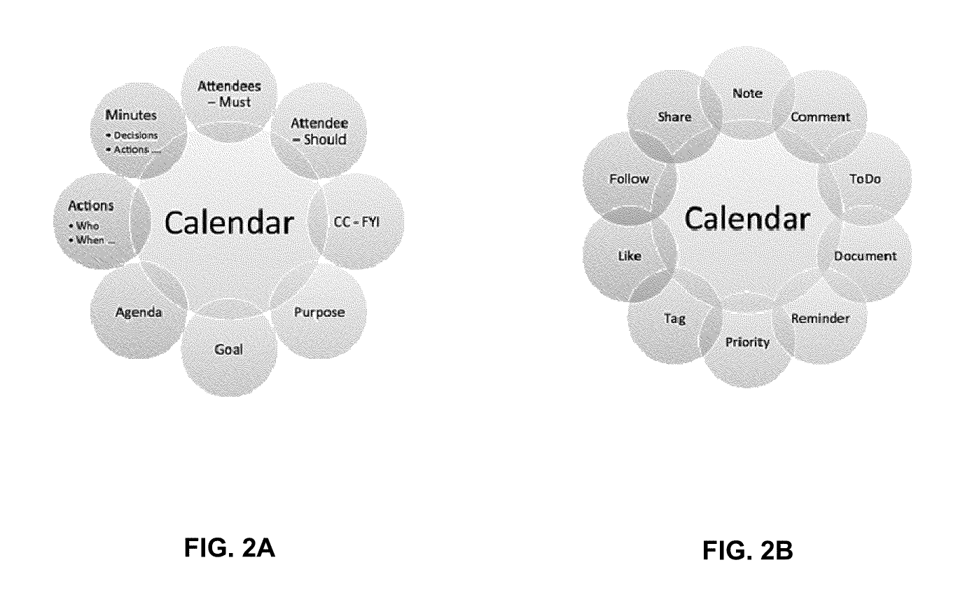

FIG. 1 is a block diagram illustrating an example of an integrated communication and collaboration system according to one embodiment of the invention. Referring to FIG. 1, the integrated system includes variety of workplace management systems or components and provides an integrated user interface to allow various users or clients to access the resources of the integrated system. In one embodiment, the integrated system includes a communication system (e.g., email system), a calendar system, a collaboration system (e.g., chat, conferencing system), content sharing system (e.g., social networking system), etc. As shown in FIG. 1, a user can access some or all of these resources via an integrated or uniform user interface over a network. In addition, the integrated system also provides a set of application programming interfaces (APIs) to communicate with (or synchronized with) third party entities or servers, such as, for example, third-party calendar systems, ERP systems, customer relationship management (CRM) systems, etc. Furthermore, all of these components are interrelated or communicate with each other. A user can access one component or one type of information through another component or another type of information, as shown in FIGS. 2A-2B. In the examples as shown in FIGS. 2A-2B, a user can access a variety of information or data from its calendar.

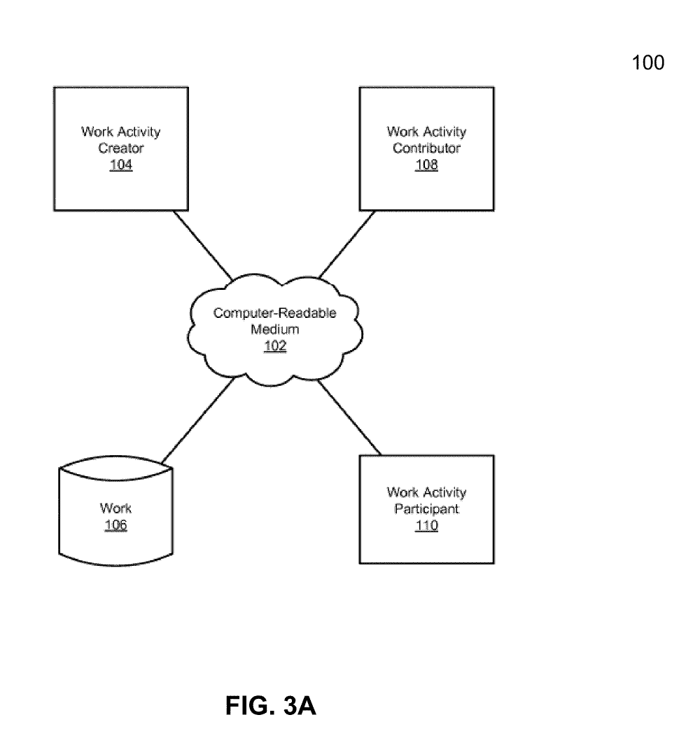

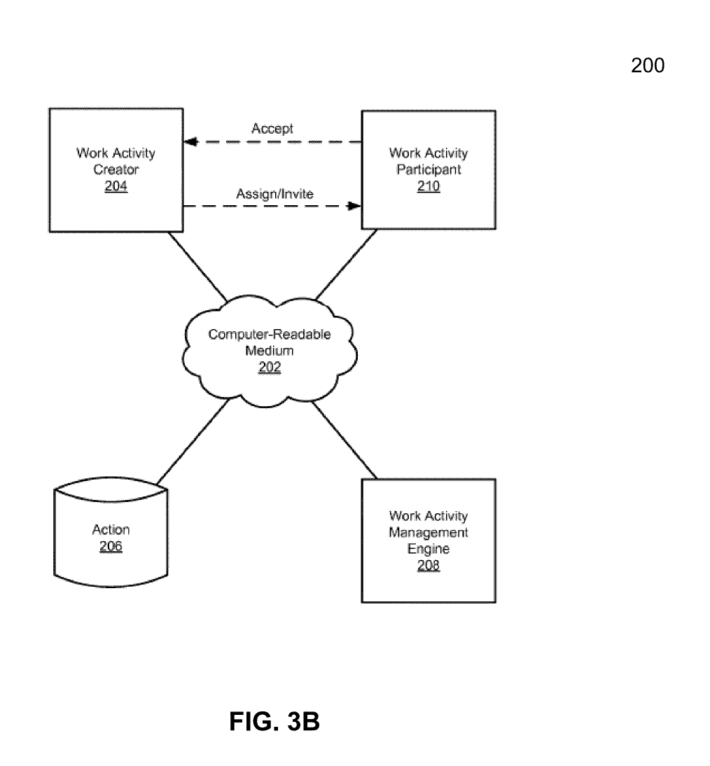

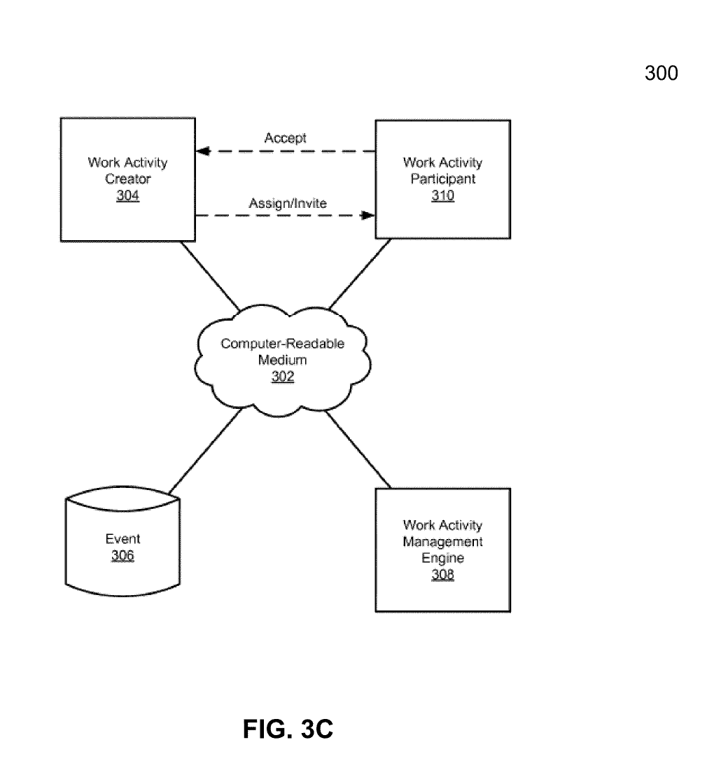

FIG. 3A depicts a diagram of an example of a system for generating and managing work activities according to one embodiment. The system 100 of FIG. 3A includes a computer-readable medium 102, a work activity creator 104, a work data store 106, a work activity contributor 108, and a work activity participant 110. The work activity creator 104, the work data store 106, the work activity contributor 108, and the work activity participant 110 are coupled to each other through computer readable medium or network 102.

As used in this application, data stores are intended to include repositories having any applicable organization of data, including tables, comma-separated values (CSV) files, traditional databases (e.g., SQL), or other applicable known or convenient organizational formats. Data stores can be implemented, for example, as software embodied in a physical computer-readable medium on a general- or specific-purpose machine, in firmware, in hardware, in a combination thereof, or in an applicable known or convenient device or system. Data store associated components, such as database interfaces, can be considered “part of’ a data store, part of some other system component, or a combination thereof, though the physical location and other characteristics of data store-associated components is not critical for an understanding of the techniques described in this application.

Data stores can include data structures. As used in this application, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The data stores, described in this application, can be cloud-based data stores. A cloud-based data store is a data store that is compatible with cloud-based computing systems.

In one embodiment, the work activity creator 104 is to generate work activities. In one example, a work activity includes or is related to one or a plurality of responsibilities, the fulfillment of which are part of reaching an objective. In another example, a work activity includes or is related to one or a plurality of responsibilities, the fulfillment of which are part of reaching a business objective. In still another example, a business objective includes a goal of an organization, an entity within an organization, or a person. For example, the work activity can be created by a manager of a sales organization and the work activity can be related to a goal of a number of units to sell by the work organization. In yet another example, the work activity is part of a workflow of achieving an objective.

In one embodiment, a work activity created by the work activity creator 104 includes an action. In one example, an action includes a task that can be completed by a user. In another example, an action is task that can be completed by a user in reaching an objective. For example, an action can be making a sales call to a customer to achieve a sales goal. In a further example, an action is a learn task that instructs a user to review and/or learn the specifications of a product. In still another example, an action is an ignore task that instructs a user to ignore a previously created work activity or informs that a user will ignore a previously created work activity. In yet another example, an action is an approve task that instructs a user to approve a deliverable, such as a proposal. In still a further example, an action includes a plurality of subactions that are executed in performing the action. In one example, an actions includes a plurality of sub-actions that can be assigned to multiple users for execution by the users.

In one embodiment, a work activity created by the work activity creator 104 includes an event. In an example, an event defines an occurrence that may or may not take place in the future. In one example, an event is defined to include a time at which the event will occur. In another example, an event is defined to include the location and/or attendees or participants in the event. In yet another example, an event is defined to include an agenda that specifies what occurrences will happen at the event, who is responsible for ensuring that the occurrences do happen, and what time the occurrences will happen at the event. For example, if the event is a conference, the agenda can specify what speakers will be speaking at the conference and what times the speakers will speak at the conference. In still another example, an event is defined to include a goal or an objective of the event. For example, if an event is meeting a potential client for lunch, the event can be defined to include the goal of networking. In still a further example, an event includes one or a plurality of actions that are associated with an event. For example, if the event is a meeting and a participant in the meeting is performing a product demonstration, then the event can be defined to include the action of preparing for the product demonstration.

In one embodiment, a work activity created by the work activity creator 104 includes a to-do item. In an example, a to-do item is an item that the work activity creator 104 creates for themselves. In one example, a to-do item defines an action that a user it to perform. For example, a to-do item can ask or remind a user to review and approve a deliverable, such as a proposal. In another example, a to-do item defines an event that a user is to attend, or an action that a user is to perform in connection with an event. For example, a to-do item can instruct or remind a user to prepare for a product demonstration in preparation for a product demonstration that will be given at a meeting. In still another example, a to-do item includes a date or time by which an action, that is the subject of the to-do item, should be completed or performed. In still another example, a to-do item includes a time and a location at which an event, that is the subject of the to-do item, is occurring.

In one embodiment, a work activity created by the work activity creator 104 includes a for your information (hereinafter referred to as “FYI”) item. In one example the FYI item coveys a message to a user. In another example, the FYI item is independent of an action, an event, and/or a to-do item. For example, the FYI item can be a humorous message sent to a user that is unrelated to an action that the user will perform, or an event that the user is associated with or will attend.

In one embodiment, a work activity created by the work activity creator 104 is included as part of a message that is sent to a user. In one example, the message is an alert that is sent to a user. In another example, the message is a notification that is sent to a user. In still another example, the message is a reminder that is sent to a user. In yet another example, the message is an electronic mail (hereinafter referred to as “email”) message that is sent to a user. In a further example, the message is a chat message that is sent to a user. In still a further example, the message is a forum message that is posted to a forum in which a user is involved. In the examples, a user can be a contributor to the work activity, a participant to the work activity, or a creator of the work activity.

In one embodiment, the work activity creator 104 attaches an object to be included as part of a work activity. In an example, an attached object is associated with the work activity to which it is attached. In another example, the attached object is associated with an event that is a work activity. For example, an attached object can list the agenda and/or the time and location of an event. In one example, an attached object is an object that is utilized in performing an action. For example, if the action is to approve a proposal, the attached object can be the proposal. Further in the one example, the action can be part of or defined by a to-do item or an event.

In one embodiment, the work activity creator 104 creates a work activity that specifies which users to send a message that includes the work activity. In one example, the users to whom the message is sent include work activity contributors, such as work activity contributor 108, and work activity participants, such as work activity participant 110. In another example, the work activity creator 104 uses a contacts list to create a work activity that specifies which users to send a message that includes the work activity.

In one embodiment, the work activity creator 104 specifies which users to assign responsibilities associated with a work activity. In an example, the users are work activity participants. In one example, the responsibilities include tasks that are performed in completing an action. Further in the one example, the action can be associated with an event or a to-do item. In another example, the responsibilities include an event to be attended as part of a work activity. In still another example, the work activity creator 104 assigns specific responsibilities to specific users. In yet another example, the work activity creator 104 assigns specific tasks to a pool of users. For example, the work activity creator 104 can assign the responsibilities of making sales calls to specific customers to a group of sales associates. Further in the yet another example, the users in the pool can select which responsibilities to take. In still another example, the work activity creator 104 assigns responsibilities associated with a work activity to themselves.

In one embodiment, the work activity creator 104 creates a priority for a work activity. In an example, the work activity creator 104 creates separate priorities at different priority levels. Further in an example, the levels can correspond to urgency or importance. In one example, the work activity creator 104 creates separate priorities for actions or sub-actions included as part of or associated with a work activity. In another example, the work activity creator 104 creates separate priorities for occurrences that will take place during an event according to an agenda. For example, if the event is a conference with multiple speakers, the work activity creator 104 can create different priorities indicating different priority levels for the speakers based on the relevance of the speakers to the work activity creator 104.

In one embodiment, the work activity creator 104 creates a tag for a work activity. In one example, the tag identifies the type of work activity or the subject matter of a work activity. For example, if the work activity is an event with a particular organization, then the tag can identify that the work activity is an event and the organization associated with the event.

In one embodiment, the work data store 106 functions to store work activities created by the work activity creator 104. In one example, a work activity include the users to send a message to regarding the work activity. In another example, a work activity includes the users to which responsibilities associated with the work activity are assigned. In still another example, a work activity includes the priorities, including priority levels, of or associated with the work activity. In a further example, a work activity is stored in the work data store 106 as it is created by the work activity creator 104. In still another example, a work activity is stored in the work data store 106 before a message regarding the work activity is sent to respective users.

In one embodiment, the work activity contributor 108 provides input regarding a work activity. In one example, the input includes comments related to a work activity. For example, if the work activity is an action of achieving a sales goal, then the comments can include advice for achieving the sales goal. In another example, the input includes information that is used to assign responsibilities associated with the work activity to a user or participant. For example, the work activity creator 104 can use the input from the work activity contributor 108 to assign responsibilities associated with the work activity. Alternatively, the work activity contributor 108 can assign responsibilities associated with the work activity directly based on the input. In another example, the input includes suggested changes to a work activity. For example, the work activity contributor 108 can discover an error in a work activity and suggest a change to the work activity in order to correct the error. Input generated by the work activity contributor 108 and any changes to the work product made as a result of the input can be stored in the work data store 106.

In one embodiment, the work activity participant 110 is a user who is assigned responsibilities or is part of a pool of users who are assigned responsibilities related to the work activity. In one example, the work activity participant 110 is the same as the work activity creator 104. In another specific implementation, the work activity participant 110 accepts responsibilities that are assigned to them as part of the work activity. For example, if the responsibilities assigned to the work activity participant 110 indicate attending an event at a certain time, the work activity participant 110 can accept the responsibility of attending the event. Similarly, if the responsibilities assigned to the work activity participant indicate executing a sales call on a specific day, the work activity participant 110 can accept the responsibility of executing the sales call on the specific day. In another example, the work activity can be updated to reflect that the work activity participant 110 has accepted an assigned responsibility. Further in another example, the work activity stored in the work data store 106 can be updated to reflect that the work activity participant 110 has accepted an assigned responsibility. In still another example, a message indicating that the work activity participant 110 has accepted an assigned responsibility can be sent to users associated with the work activity, including the work activity creator 104 and/or the work activity contributor 108, after the work activity participant 110 accepts the assigned responsibility.

In one embodiment, the work activity participant 110 modifies responsibilities that are assigned to them as part of the work activity. In one example, the work activity participant modifies the responsibility to change the time that an event occurs. In another example, the work activity participant modifies the responsibility to change the scope of the responsibilities assigned to them as part of the work activity. For example, if the responsibilities include executing five sales calls on a specific day, the work activity participant 110 can modify the responsibility to include executing three sales calls on the specific day. In still another example, the modified responsibilities are sent to users, including the work activity creator 104 and/or the work activity contributor 108, to determine whether the modified responsibilities are acceptable. If the modified responsibilities are deemed acceptable, then the work activity stored in the work data store 106 is modified to indicate that the work activity participant 110 has accepted the modified responsibilities.

In one embodiment, the work activity participant 110 declines acceptance of responsibilities that are assigned to them as part of the work activity. In one example, the work activity participant 110 declines acceptance of responsibilities and modifies the responsibilities that are assigned to them. In another example, a message indicating that the work activity participant 110 declines the assigned responsibilities is sent to users, including the work activity creator 104 and/or the work activity. In yet another example, the work activity creator 104 and/or the work activity contributor 108 can reassign the responsibilities to another work activity participant or modify the responsibilities assigned to the work activity participant 110. In a further example, the work activity is updated in the work data store 106 to reflect that the work activity participant 110 declined acceptance of the assigned responsibilities.

In one embodiment, functionalities provided to the work activity creator 104, the work activity contributor 108, and the work activity participant 110 and associated with generating and/or managing work activities are distributed across multiple respective devices used by the work activity creator 104, work activity contributor 108, and work activity participant 110 in the network. In one example, the network is a peer-to-peer network. In another example, the work data store 106 is distributed across multiple devices used by the respective work activity creator 104, work activity contributor 108, and the work activity participant 110. In another specific implementation, functionalities provided to the work activity creator 104, the work activity contributor 108, and the work activity participant 110 in generating and/or managing work activities, are provided by a service provider over the computer-readable medium 102 to respective devices used by the work activity creator 104, the work activity contributor 108, and the work activity participant 110. In one example, the work data store 106 is a cloud-based data store.

In one embodiment, functionalities provided to the work activity creator 104, the work activity contributor 108, and the work activity participant and associated with generating and/or managing work activities integrate with other systems. In one example, the functionalities integrate with other calendar systems, such as Google® Calendars or Microsoft® Outlook. For example, if the work activity participant 110 accepts an invitation/responsibility to attend an event, then the other calendar systems can be updated to reflect the accepted responsibility to attend the event. In another example, information from other systems, such as other calendar systems is used in performing the creation and/or management of work activities. For example, if another calendar system includes an entry that a user is busy on a specific day, then the work activity can be created to include or move an event on another day.

FIG. 3B depicts a diagram of an example of a system for generating and managing work activities that include actions according to one embodiment. The example system 200 in FIG. 3B includes a computer-readable medium 202, a work activity creator 204, an action data store 206, a work activity management engine 208, and a work activity participant 210. The work activity creator 204, the action data store 206, the work activity management engine 208, and the work activity participant 210 are coupled to each other through the computer-readable medium 202.

In one embodiment, the work activity creator 204 functions according to an applicable work activity creator, such as the work activity creators described in this application. In another specific implementation, the work activity participant 210 functions according to an applicable work activity participant, such as the work activity participants described in this application.

In one embodiment, the work activity creator 204 functions to create a work activity that defines an action. In one example, the action is a predefined action that is stored in the action data store 206. For example, the predefined action can be reviewing a proposal. In another example, the action is a customized action that is created by the work activity creator 204. For example, the action can be an action that is unique to a particular user or a particular customer or product, such as performing a sales call to a specific customer. In another example the work activity includes information associated with performing the action. In one example, the information associated with performing the action includes a reply date by which the action must be accepted. In another example, the information associated with performing the action includes a date by which the action must be completed or a date at which the action is due. In still another example, the work activity that defines an action includes a work activity participant 210, which is assigned or invited to perform responsibilities associated with performing the action.

In one embodiment, the work activity that defines an action and is created by the work activity creator 204 is stored in the action data store 206. In one example, the work activity includes the information described in the preceding paragraph. In another example, the work activity includes information described with reference to FIG. 1 that is included as part of or is associated with a work activity that defines an action.

In one embodiment, the work activity management engine 208 functions to send a message associated with the work activity that informs the work activity participant 210 that they have been assigned or invited to perform responsibilities associated with performing the action defined by the work activity. In another specific implementation, the work activity management engine 208 functions to update the work activity when the work activity participant has accepted responsibilities associated with performing the action defined by the work activity. In one example, the work activity management engine 208 updates the work activity stored in the action data store 206 that defines the action to indicate that the work activity participant has accepted responsibilities in performing the action.

In one embodiment, the work activity management engine 208 function to manage the work activity as tasks associated with performing the action defined by the work activity are completed. In one example, the work activity management engine 208 determines when a task associated with performing the action is completed. In another example, the work activity management engine 208 updates the work activity stored in the action data store 206 that defines an action to indicate that a task associated with the action has been completed. In yet another example, the work activity management engine 208 send a message to the work activity creator 204 which informs the work activity creator 204 that a task associated with the action has been completed. In still another example, the work activity management engine 208 modifies the work activity that defines the action, based on the completion of a task associated with the action. For example, if a second task associated with performing the action defined by the work activity, no longer needs to be executed in order to perform the action after completion of a first task associated with the action, then the work activity management engine 208 can remove the task from the work activity. Further, the work activity management engine 208 can send a message to the work activity participant who has the responsibility of performing the second task informing the work activity participant 210 that they no longer need to perform the second task.

FIG. 3C depicts a diagram of an example of a system for generating and managing work activities that include events according to one embodiment. The example system 300 in FIG. 3C includes a computer-readable medium 302, a work activity creator 304, an event data store 306, a work activity management engine 308, and a work activity participant 310. The work activity creator 304, the event data store 306, the work activity management engine 308, and the work activity participant 310 are coupled to each other through the computer-readable medium 302.

In one embodiment, the work activity creator 304 functions according to an applicable work activity creator, such as the work activity creators described in this application. In another specific implementation, the work activity participant 310 functions according to an applicable work activity participant, such as the work activity participants described in this application.

In one embodiment, the work activity creator 304 functions to create a work activity that defines an event. In one example, the event includes an action. Further in the one example the action is a predefined action that is stored in the event data store 306. For example, the predefined action can be prepare a presentation for a conference. In another example, the action is a customized action that is created by the work activity creator 304. For example, the action can be an action that is unique to a particular user, a particular customer, a particular product, or a particular event. In another example the work activity includes information associated with the event. In one example, the information associated with the event includes the time and/or place of the event. In another example, the information associated with the event includes an agenda for the event. In still another example, the work activity that defines an event includes a work activity participant 310, which is assigned or invited to perform responsibilities associated with the event. In one example, the responsibilities associated with the event include attending the event.

In one embodiment, the work activity that defines an event and is created by the work activity creator 304 is stored in the event data store 206. In one example, the work activity includes the information described in the preceding paragraph. In another example, the work activity includes information described with reference to FIG. 1 that is included as part of or is associated with a work activity that defines an event.

In one embodiment, the work activity management engine 308 functions to send a message associated with the work activity that informs the work activity participant 310 that they have been assigned or invited to perform responsibilities associated with the event defined by the work activity. In another specific implementation, the work activity management engine 308 functions to update the work activity when the work activity participant has accepted responsibilities associated with the event defined by the work activity. In one example, the work activity management engine 308 updates the work activity stored in the event data store 306 that defines the event to indicate that the work activity participant 310 has accepted responsibilities in associated with the event defined by the work activity.

In one embodiment, the work activity management engine 308 function to manage the work activity as actions included as part of the event defined by the work activity are completed. In one example, the work activity management engine 308 determines when an action included as part of an event is completed. In another example, the work activity management engine 308 updates the work activity stored in the event data store 306 that defines an event to indicate that an action included as part of an event has been completed. In yet another example, the work activity management engine 308 send a message to the work activity creator 304 which informs the work activity creator 304 that the action associated with the event has been completed. In still another example, the work activity management engine 308 modifies the work activity that defines the event, based on the completion of an action associated with the event. For example, if a second action associated with the event defined by the work activity, no longer needs to be executed after completion of a first action associated with the event, then the work activity management engine 308 can remove the second action from the work activity. Further, the work activity management engine 308 can send a message to the work activity participant who has the responsibility of performing the second action informing the work activity participant that they no longer need to perform the second action.

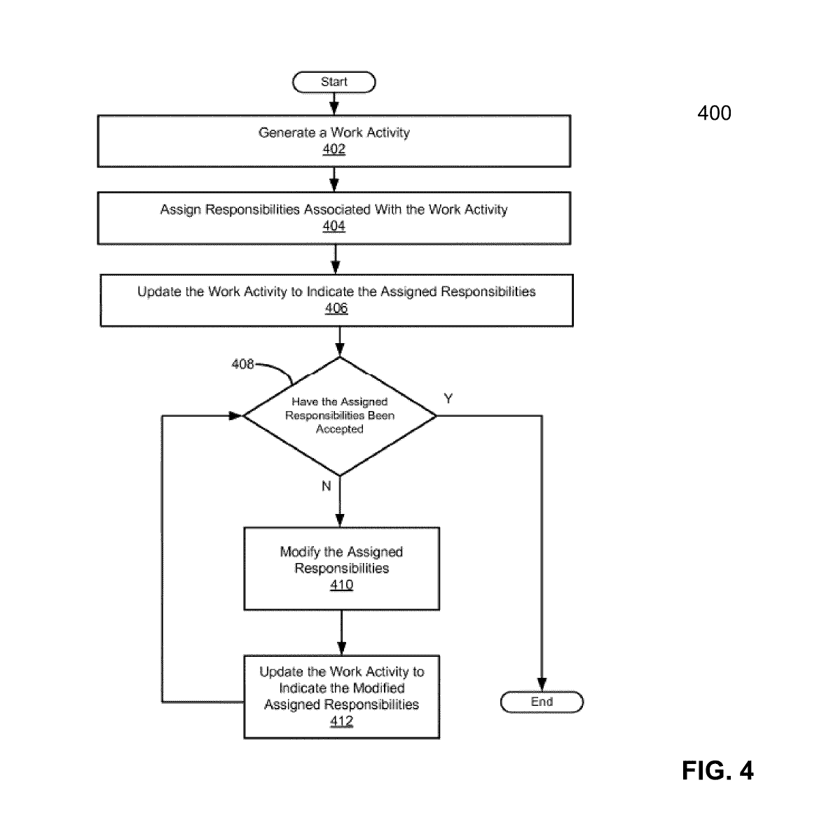

FIG. 4 illustrates a diagram of a flowchart of an example method for generating and managing work activities according to one embodiment. The flowchart 400 begins at module 402 with generating a work activity by a work activity creator. In one example, the work activity includes an action. In another example, the work activity includes an event. In yet another example, the work activity includes a to-do item. In still another example, the work activity includes a FYI item.

The flowchart continues to module 404, where responsibilities associated with the work activity are assigned to a work activity participant. In one example, the work activity participant is the same as the work activity creator. In another example, the responsibilities include tasks for execution in performing an activity, including performing an action or attending an event. In yet another example, the responsibilities are associated with a plurality of subactions as part of performing an action.

The flowchart continues to module 406, where the work activity is updated to indicate the assigned responsibilities. In one example, the work activity is updated to identify the work participants that were assigned the responsibilities. In another example, the work activity is updated to include when the assigned responsibilities are to be performed or are due. In still another example, the work activity is updated to include the priority of the responsibilities.

The flowchart continues to decision point 408 where it is determined whether the assigned responsibilities have been accepted. In one example, it is determined from input received from the work activity participant that was assigned the responsibilities whether the assigned responsibilities were accepted. In an example, the input received from the work activity participant indicates that the work activity participant has declined acceptance of the responsibilities. In another example, the input received from the work activity participant includes modified responsibilities that the work activity participant indicates that they will accept. If it is determined at decision point 408, that the work activity participant accepted the assigned responsibilities, then the flowchart ends.

If at decision point 408, it is determined that the work activity participant has declined acceptance of the assigned responsibilities, then the flowchart continues to module 410. At module 410, the flowchart includes modifying the assigned responsibilities. In one example, modifying the assigned responsibilities, includes re-assigning the responsibilities to another work activity participant. In another example, the assigned responsibilities are modified according to input received from the work activity participant whom the responsibilities were assigned. For example, the input can indicate the change in responsibilities that the work activity participant is willing to accept.

The flowchart continues to module 412 where the work activity is updated to indicate the modified assigned responsibilities. In one example, the work activity is updated to indicate the new work activity participants whom the responsibilities are assigned. In another example, the work activity is updated to reflect the change in responsibilities that are assigned to the new work activity participant. The flowchart then continues back to decision point 408 where it is determined whether the modified assigned responsibilities are accepted by a work activity participant.

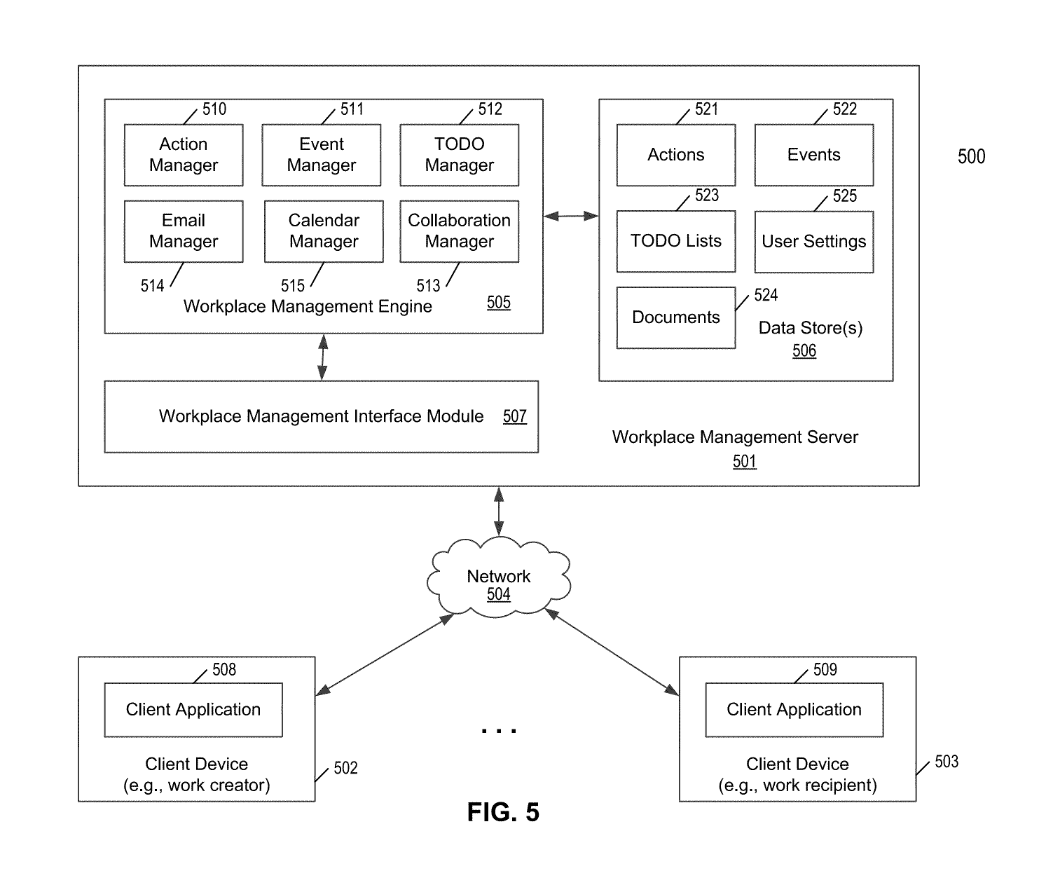

FIG. 5 is a block diagram illustrating an example of an integrated communication and collaboration system according to one embodiment of the invention. For example, system 500 may be implemented as part of the systems as shown in FIGS. 1-3. System 500 includes one or more client devices 502-503 communicatively coupled to workplace management server 501 over network 504. Workplace management server 501 may represent a work activity management engine as described above. Client devices 502-603 may represent work activity participants as described above. Client devices 502-503 may be any type of data processing devices such as a server, a personal computer (e.g., desktops, laptops, and tablets), a “thin” client, a personal digital assistant (PDA), a Web enabled appliance, a gaming device, a media player, or a mobile device (e.g., Smartphone), etc. Server 501 may be a single server or a cluster of multiple servers, such as a web server, application server, content server or other servers providing remote services (e.g. Web search, cloud storages, gaming, social networking etc.) for users of client devices 502-503 (e.g., work activity creators, contributors, and participants). Network 107 may be any type of networks such as a local area network (LAN), a wide area network (WAN) such as the Internet/intranet, cellular networks, secured/open networks, wired/wireless networks or a combination thereof.

According to one embodiment, the integrated communication and collaboration platform may include a server component hosted by server 501 and a client component hosted by client applications 508-509 at client devices 502-503. For example, client applications 508-509 may represent the local client application, similar to the Microsoft Outlook™ client. In such a configuration, data is exchanged between server 501 and client applications 508-509. Data or signals received from server 501 may be interpreted, analyzed, arranged, rendered, and/or displayed via a graphical user interface of client devices 502-503. Alternatively, client applications 508-509 are thin clients such as a browser application while server 501 is a cloud server or servers. In such a configuration, data may be rendered at server 501 and transmitted to client devices 502-503 as documents or presentations, such as, for example, hypertext markup language (HTML) or Web pages and displayed by client applications 508-509 at client devices 502-503. Alternatively, server 501 may generate executable code, such as HTML or extensible markup language (XML) code, or JavaScript, and sends the executable code to client devices 502-503. The executable code is then executed by the corresponding client applications 508-509 to process the data and render the graphical user interface displayed in a display device of client devices 502-503.

Server 501 may be a workplace management server associated with a particular enterprise entity, while users of client devices 502-503 may be members of the organization associated with server 501. In one embodiment, management server 501 includes, but is not limited to, workplace management engine 505 (also referred to as management unit or management logic), one or more data stores 506, and workplace management interface module 507 (also referred to as interface unit or interface logic). Interface module 507 is to communicate with client devices 502-503 based on data or information provided by management engine 505, where management engine 505 may represent a work activity management engine as shown in FIGS. 1-3. For example, interface module 507 may generate GUI data and/or render a GUI page based on the data or commands received from management engine 505 and transmit the GUI page to client devices 502-503 to be presented to users by client applications 508-509 of client devices 502-503.

According to one embodiment, workplace management engine 505 is to provide an integrated workplace communication and collaboration platform to users and to manage work activities for the users. Workplace management engine 505 may further include other functionalities, such as, for example, workflow management, project management, etc. The work activity data is stored in data store 506, which may represent data stores as shown in FIGS. 1-3. A work activity may present any of the work related activities, such as, for example, an action, an event, a to-do (TODO or todo) list, an email, a calendar item, a reminder, a note, a notification or alert, comments, tags, a shared document, or a combination thereof.

In one embodiment, an action can represent tasks, request for review, poll, quiz, approval, request, etc. Companies can define their own list of actions). Actions require sender, recipient, specific action requested, and may have due date, duration, and dependency. An event includes meetings, for example, for staff, team, project, seminar, training, party, conference call, etc.) Perhaps phone calls can be included here. Events have specific date/time/duration, attendees, plus potentially a location info. Some events may also have purpose, goal, agenda, actions, etc. A todo item includes anything that the user needs to do on his own. May or many not require anyone else. May or may not be scheduled to date/time on calendar). TODO has categories/folders like “today, tomorrow, this week, next week, this month, someday, etc. Companies and user can define their own folder/categories for projects, people, event, etc.

According to one embodiment, management engine 505 includes, but is not limited to, action manager 510, event manager 511, TODO manager 512, email manager 514, calendar manager 515, and collaboration manager 513. Action manager 510 is to manage actions 521 of actionable messages while event manager 511 is to manage events 522 of actionable messages. TODO manager 512 is to manage TODO lists 523. Email manager 514 is to manage the regular emails (e.g., those without an action or event). Calendar manager 515 is to manage calendar information (e.g., scheduling, alerts, reminders) for the users. Collaboration manager 513 is to manage and conduct collaboration sessions (e.g., online meeting or Web conferencing) for the users, for example, from the same operating environment or user interface of other functions (e.g., emails, calendars), which managed by user interface module 507.

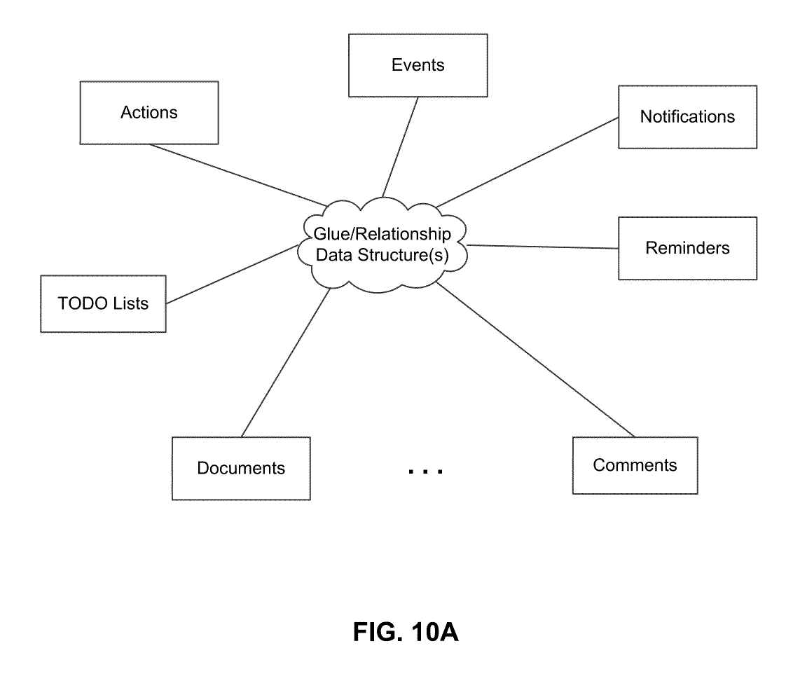

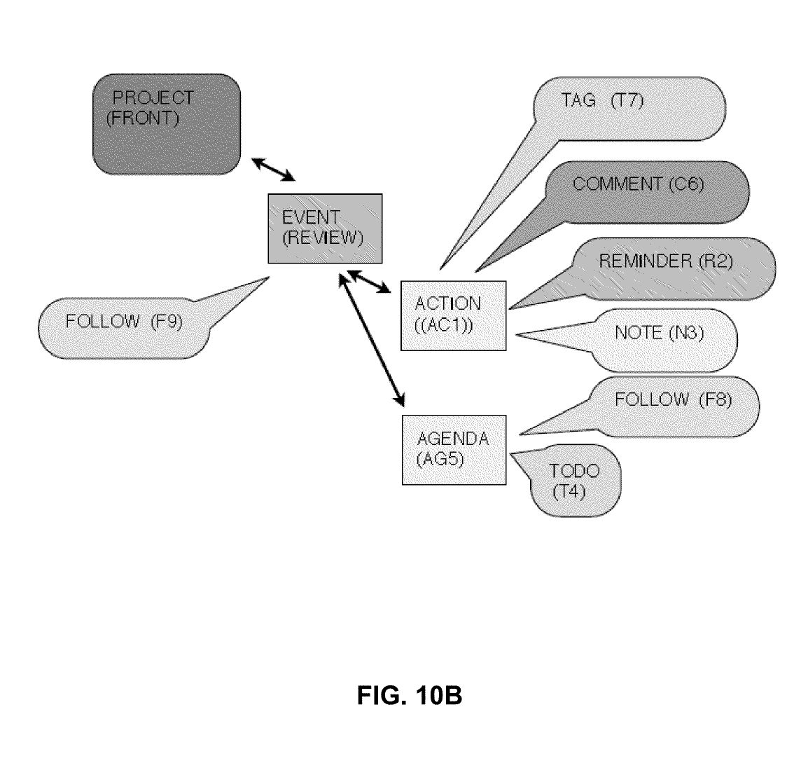

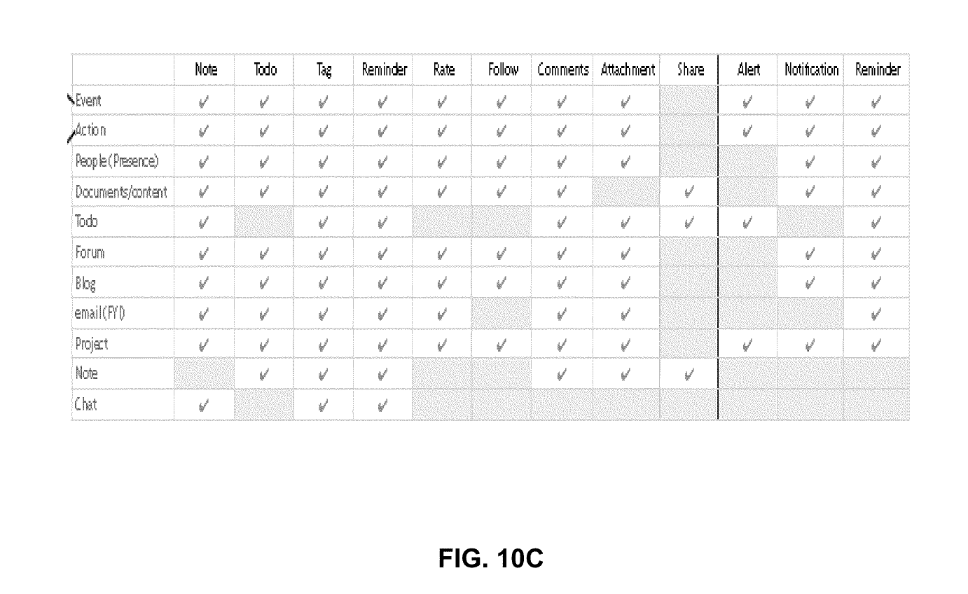

In addition, data store 506 may store regular email information and calendar information of the users (not shown). Data store 506 may also store documents 524 that may be associated with or linked to any of actions 521, events 522, TODO lists 523, etc. Data store 506 may further store user preferences or settings 525 of the users. Data store 506 may be implemented in one or more databases associated with each other. Data store 506 may maintain a search or query interface to allow management engine 505 to search based on a variety of categories or terms. Data stored in data store 506 (e.g., actions 521, events 522, TODOs 523) may be linked with each other, for example, via a glue or dependency data structure. One can search based on one work activity, such as an action, an event, and/or a TODO item, to identify or determine another work activity or item that has been attached therein, as shown in FIGS. 10A-10C. The user interface provided by user interface module 507 allows a user to associate or link one work activity to another work activity. The relationships or dependencies of the work activities are stored in data store 506, for example, in a dependency data structure or table or as part of metadata of each of the related work activities.

According to one embodiment, a user, as a work activity creator or sender, can compose an actionable message (e.g., an actionable email) using a graphical user interface (GUI) provided by interface module 507 of an integrated communication and collaboration platform (also referred to as a workplace management platform) an presented by a client application such as client applications 508-509 over a network. The actionable message includes an action to be performed by another user or recipient, in this example, a user associated with client device 502 as a work activity participant. The action specified in the actionable message can be a task, a meeting event, or some other actions that require the recipient to do something, which may be managed by action manager 510 and/or event manager 511 and stored in data store 506 as part of actions 521 and/or events 522.

The sender, in this example, the user of client device 502, can specify in an actionable message a due date by which the action to be performed, a reply-by date by which the recipient has to acknowledge (e.g., accept, decline, or request for change or RFC), and an optional duration that estimate amount of time to perform such an action. The dates can be specified in the corresponding fields (e.g., reply-by field, due date field, duration field) of a GUI page provided by user interface module 507 and displayed by client application 508. If the action is an event or meeting invitation, according to one embodiment, the sender can also specify recipient(s) who are required to attend (e.g., in a “must attend” field), recipient(s) who should attend (e.g., a “should-attend” field), and optional FYI recipient(s) who only receive the message as an FYI message (e.g., a “FYI” field). The GUI also allows a sender to display in a contact window or panel having (e.g., a sidebar window or pop-up subpanel) all the contact information of people associated with the sender. The sender can easily drag and drop a contact (e.g., an email address) of a recipient from the contact window into any of the above fields (e.g., due date, reply-by, duration, must-attend, should-attend, and/or FYI fields) in the composing window of the actionable message.

According to one embodiment, the sender can also determine whether the intended recipient has enough bandwidth to perform such an action based on the reply-by date, due date, and duration of the action. For example, once the sender specifies the recipient, the reply-by date, due date, and duration of the action, action manager 510 invokes calendar manager 515 to automatically access the calendar of the recipient (e.g., user of client device 503) to determine the availability of the intended recipient based on the reply-by date, due date, and/or duration of the action. An alert or warning may be sent or displayed to the sender if it is determined that the recipient may not have the necessary bandwidth to perform the task.

When an actionable message is sent and/or received by the intended recipient (e.g., user of client device 503), action manager 510 and/or event manager 515 automatically detects this is an actionable message with an action associated with therein that is different from an ordinary message that does not require or ask the recipient to do something. The ordinary messages are referred to as regular messages or FYI messages, which are handled by email manager 514. According to one embodiment, action manager 510 or event manager 511 places or stores the actionable messages in a dedicated folder (e.g., “Act Now” folder) while the regular messages are stored in another folder (e.g., regular inbox). As a result, the recipient can easily identify or determine whether there is an actionable message having a pending or outstanding activity that requires his or her attention.

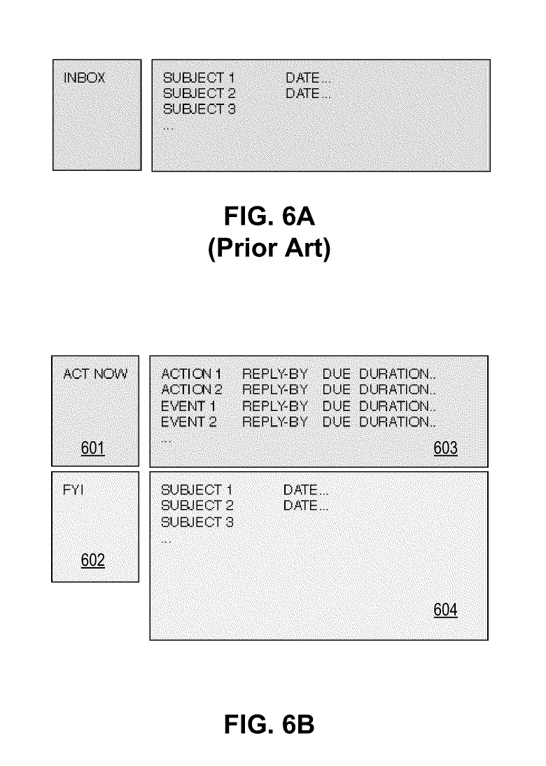

A conventional email system would have put all the emails in the same folder, such as an inbox, as shown in FIG. 6A. According to one embodiment, as shown in FIG. 6B, the actionable message placed in a dedicated folder 601 with actionable message metadata such as reply-by date, due date, and duration 603 (as well as other regular metadata such as subjects), while the non-actionable messages are placed in another folder 602 with regular metadata (e.g., subjects, dates) of the messages 604.

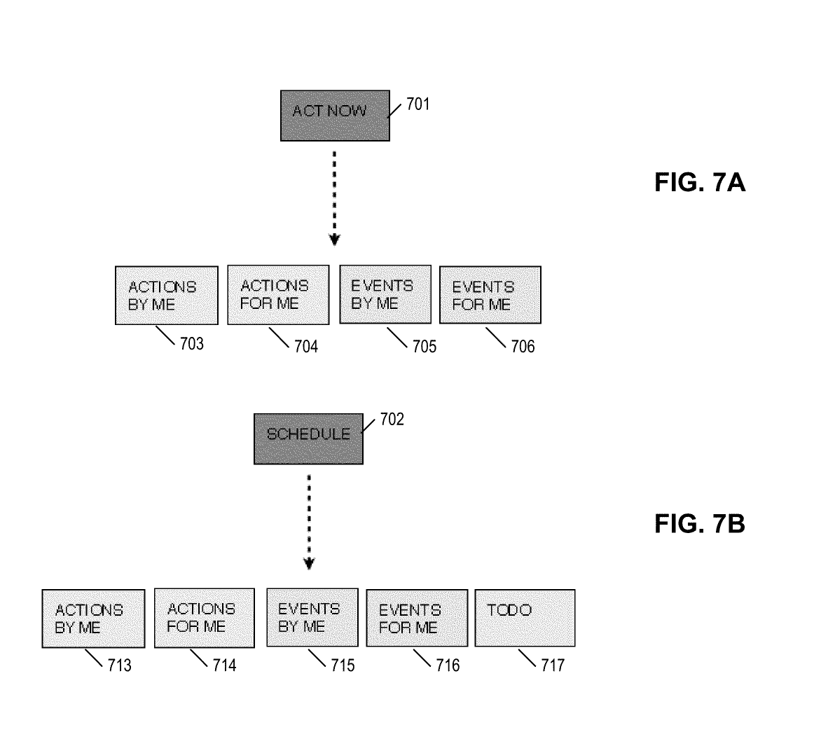

In one embodiment, the graphical user interface of the integrated platform includes a first display area or panel representing the dedicated folder to display the actionable messages and a second display area or panel to display details of an actionable message selected from the first display area. In one embodiment, the first display area includes a first tab or page to a list of actionable messages 701 as shown in FIG. 7A. The actionable messages may be categorized into multiple subfolders, including actions issued by the current user 703, actions sent or assigned to the user 704, events issued by the user 705, and events received by the user 706. The first display area further includes a second tab or page to schedule the actionable messages 702, including actions issued by the current user 713, actions sent or assigned to the user 714, events issued by the user 715, events received by the user 716, and TODO items 717.

In addition, according to one embodiment, calendar manager 515 may automatically configure a reminder or alert to remind the recipient to respond to the actionable message. For example, a reminder or alert may be triggered prior to the reply-by date of the actionable message so that the recipient can respond, for example, accepting, declining, or requesting for change. If the recipient decides to request for a change of the action, the integrated platform provides a user friendly GUI to allow the recipient and the sender to have a real-time communication session (e.g., chat, voice) to discuss the potential change right from the actionable message in question, which may be handled by collaboration manager 513.

According to one embodiment, once a recipient (e.g., user of client device 503) accepts the action, calendar manager 515 can display a calendar GUI to allow the recipient to schedule the action from the actionable message. In addition, calendar manager 515 may further determine and display one or more available time slots of the recipient based on the reply-by date, due date, and duration of the action. The available time slots may be displayed in a sub-window or subpanel currently displayed within the reading panel of the actionable message. If the action requires multiple participants or recipients (e.g., a meeting or event that requires members of a team or group associated with a particular project or department of an organization), the calendar manager 515 may display the available time slots for all of the participants of the action, such that each participant can view the availability information of other participants, which may depend upon the specific privacy settings of the participants. The participants can also conduct an in-line (e.g., while in the calendar GUI) communication session, such as a chat session, to discuss or propose an agreed-upon time slot, which is handled by collaboration manager 513. A participant can drag and drop an available time slot into a particular cell or cells (e.g., particular date or dates) of the calendar view. In response, the calendar manager 515 automatically schedules the action in the calendar database or entry associated with that particular participant as part of data store 506.

According to another embodiment, once a recipient of an actionable message accepts the action, he or she can reassign or delegate the action to another user or users. In doing so, a second actionable message may be derived from the original or first actionable message, having the same action or event embedded therein. The second actionable message is then sent to the delegated user(s), i.e., delegatee(s). The delegator may specify the same or different reply-by date, due date, or duration in the second actionable message. A delegator and a delegatee can also exchange messages regarding acceptance, rejection, or RFC of the second actionable message. In one embodiment, the scheduling of the action may be performed automatically according to a set of rules associated with the participant, manually, or in a user guided manner. The delegation information or settings may be recorded in data store 506 by action manager 510, event manager 511, and/or calendar manager 515. Similarly, a user can also set up a TODO item, which is handled by TODO manager 512.

According to another embodiment, when a calendar view is displayed, there are at least two scroll buttons, two for each of the left and right directions, displayed to scroll the calendar view at different paces or sizes of steps. The first button, which activated, causes the calendar view to scroll based on the calendar view currently displayed. For example, if the calendar is in a daily, weekly, or monthly view, the first button causes the calendar view to scroll by a day, a week, or a month, respectively. The second button, which activated, causes the calendar view to scroll in a predetermined step, e.g., only a day, regardless the current calendar view configuration. The scrolling of the calendar view may also be handled by calendar manager 515 and user interface module 507.

According to a further embodiment, a user can also conduct a collaboration session via collaboration manager 513, such as a meeting, with multiple participants within the GUI of the integrated communication and collaboration platform. The meeting GUI includes a first display area to display the presentation content shared with the participants and a second display area to display metadata of the meeting that is associated with that particular participant, which may or may not be shared with other participants. The second display area includes multiple tabs or pages including, but are not limited to, meeting agendas, meeting details, tasks associated with the meeting, attendees, and meeting minutes. A participant can select any of the tabs or pages to display the associated information in the second display area, while the shared presentation is displayed in the first display area.

Note that some or all of the components or modules as shown in FIG. 5 can be implemented as processing logic, which may include hardware, software, or a combination thereof. Each of the server 501 and client devices 502-503 may include one or more processors and a memory device to process the data handled by the modules or components as shown in FIG. 5. For example, some of the modules in management engine 505 may be loaded in a memory device and executed by a processor to perform the functions as described above. Data store 506 may be maintained in a persistent storage device such as a hard drive, where the data can be accessed by management engine 505 by loading the data from the persistent storage device into the memory. Each of the server 501 and client devices 502-503 may further include network communication hardware, such as a network interface card (NIC), wireless transceiver, etc. to communicate with each other over network 504 using a variety of communication protocols (e.g., TCP/IP protocol), as well as corresponding network stack software hosted by an operating system running within the respective devices. Other configurations or architectures may be applied herein.

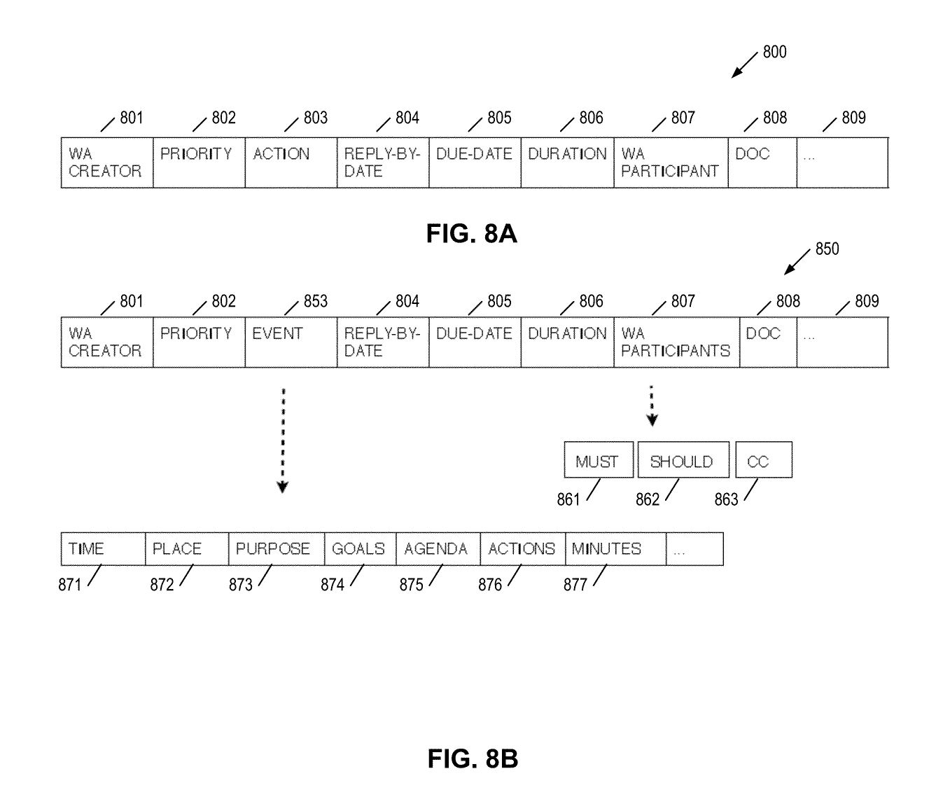

FIGS. 8A and 8B are block diagrams illustrating examples of actionable messages according to some embodiments of the invention. Referring to FIG. 8A, data structure 800 may represent an actionable message or an action data structure or entry of an action database, which may be stored as part of data store 506 of FIG. 5. Referring to FIG. 8A, action item 800 includes work activity creator or sender 801, priority of the action 802, action identifier 803 indicating that this is an action item, reply-by date 804, due date 805, duration 806, one or more participants 807, any attached document 808, as well as other information 809. Each of work activity creator 801 and participants 807 may be identified by a user identifier such as an email address of the user. A user can be a work activity creator, a work activity participant or recipient, or both. Some of these fields, such as action identifier 803 may be used by the management system to distinguish an actionable message, specifically, an action, from other types of messages.

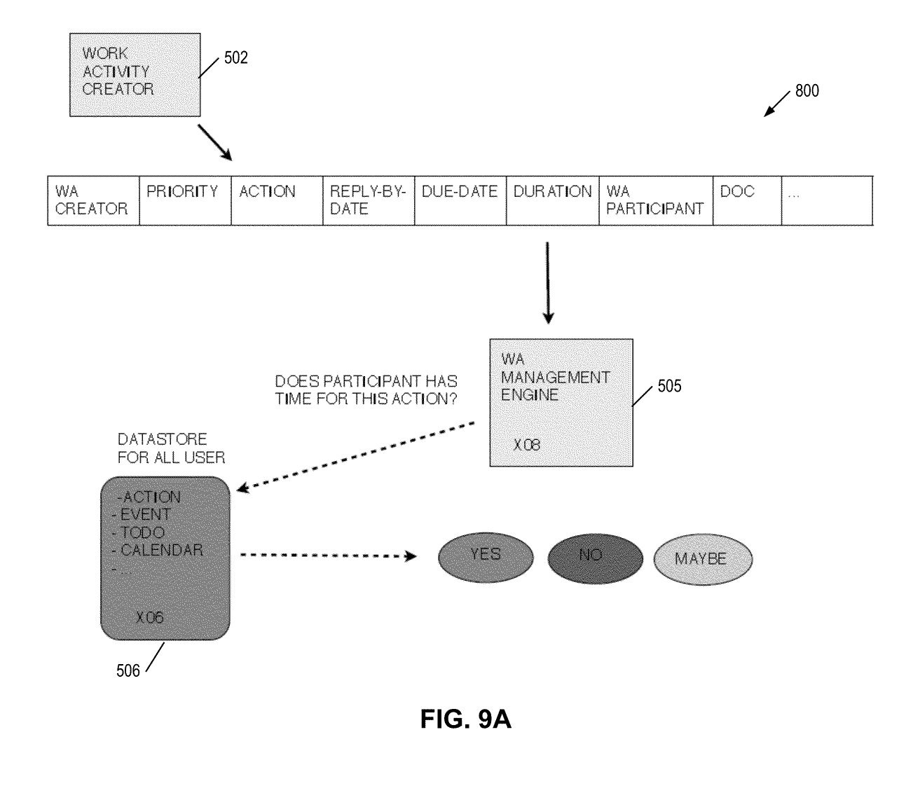

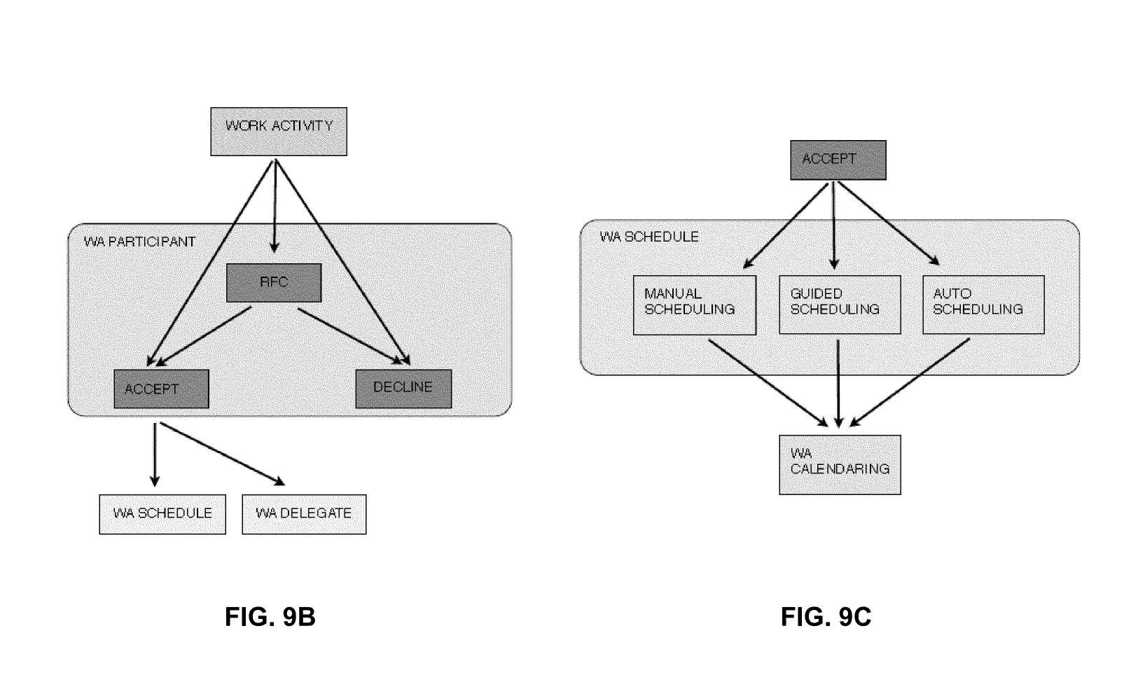

Similarly, as shown in FIG. 8B, event item or entry 850 includes similar fields as of action item 800, except that event identifier 853 indicates that this actionable item is an event item. In addition, according to one embodiment, each of the participants in an event may be associated with one of types of participants: 1) must-attend 861; 2) should-attend 862; and 3) FYI 863. In one embodiment, event field 853 may further include information identifying time of the event 871, place of the event 872, purpose of the event 873, goals of the event 874, agenda of the event 875, a task associated with the event 876, and meeting minutes 877. Note that action 876 may be linked to an action item as shown in FIG. 8A. Some of the fields as shown in FIGS. 8A and 8B may be utilized by the management engine 505 in deciding whether to place an actionable message in a dedicated folder and to schedule the action or event as shown in FIG. 9A. Alternatively, these fields may be utilized by a user to accept, decline, request for change, schedule, or delegate the item as shown in FIGS. 9B and 9C.

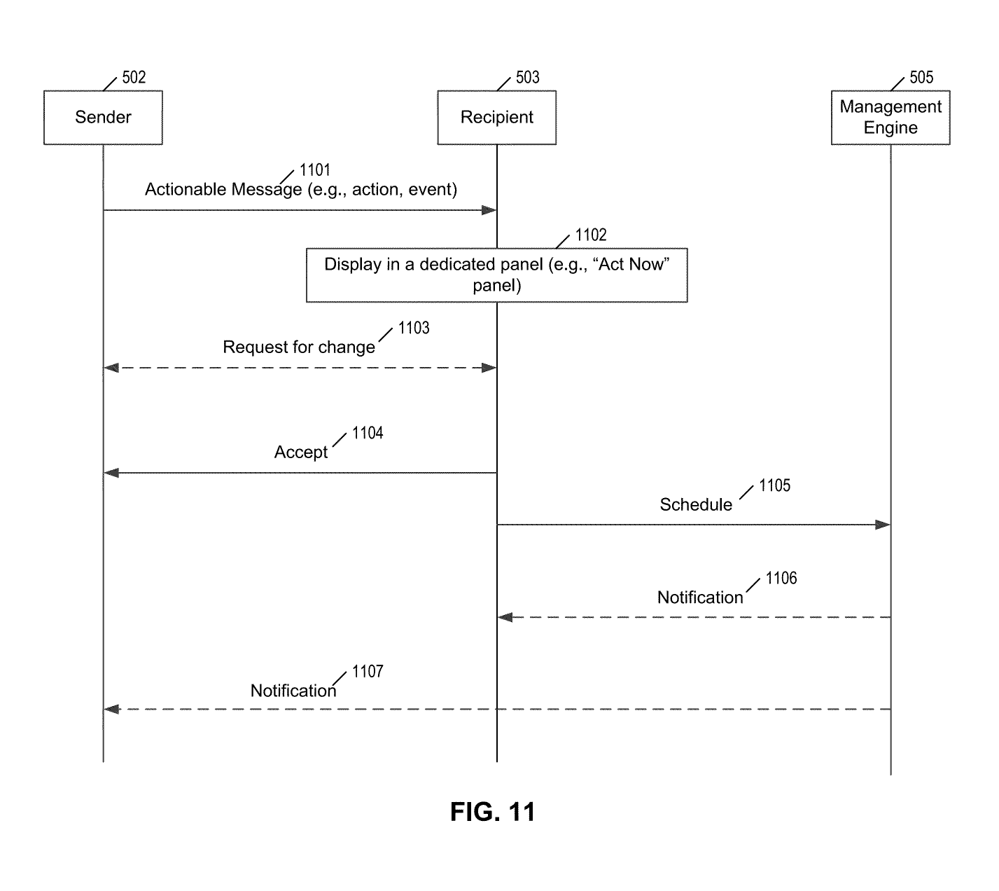

FIG. 11 is a processing diagram illustrating processing actionable messages according to one embodiment of the invention. The process may be performed by processing logic which may include hardware, software, or a combination thereof. For example, the process may be performed by participants 502-503 and management engine 505 of FIG. 5. Referring to FIG. 11, sender 502 composes an actionable message having an action or task, or an event therein. For the purpose of illustration, the term of “action” is interchangeable with the term of “task.” The actionable message may include the information as shown in FIGS. 8A and 8B, dependent upon whether the actionable message includes a task or an event. At transaction 1101, sender 502 sends the actionable message to recipient 503, for example, by specifying a work activity participant as recipient 503 in the actionable message. At transaction 1102, the system detects that this is an actionable message instead of a regular message. The actionable message is displayed in a dedicated folder of a GUI of the integrated platform displayed at a display device of recipient 503. Recipient 503 may exchange messages or chat with sender 502 requesting for changes of the task or event associated with the actionable message at transaction 1103. At transaction 1104, recipient 503 accepts the action requested in the actionable message. At transaction 1105, recipient 503 may schedule the task or event with management engine 515. The notifications to recipient 503 and sender 502 may also be configured at transactions 1106 and 1107, respectively.

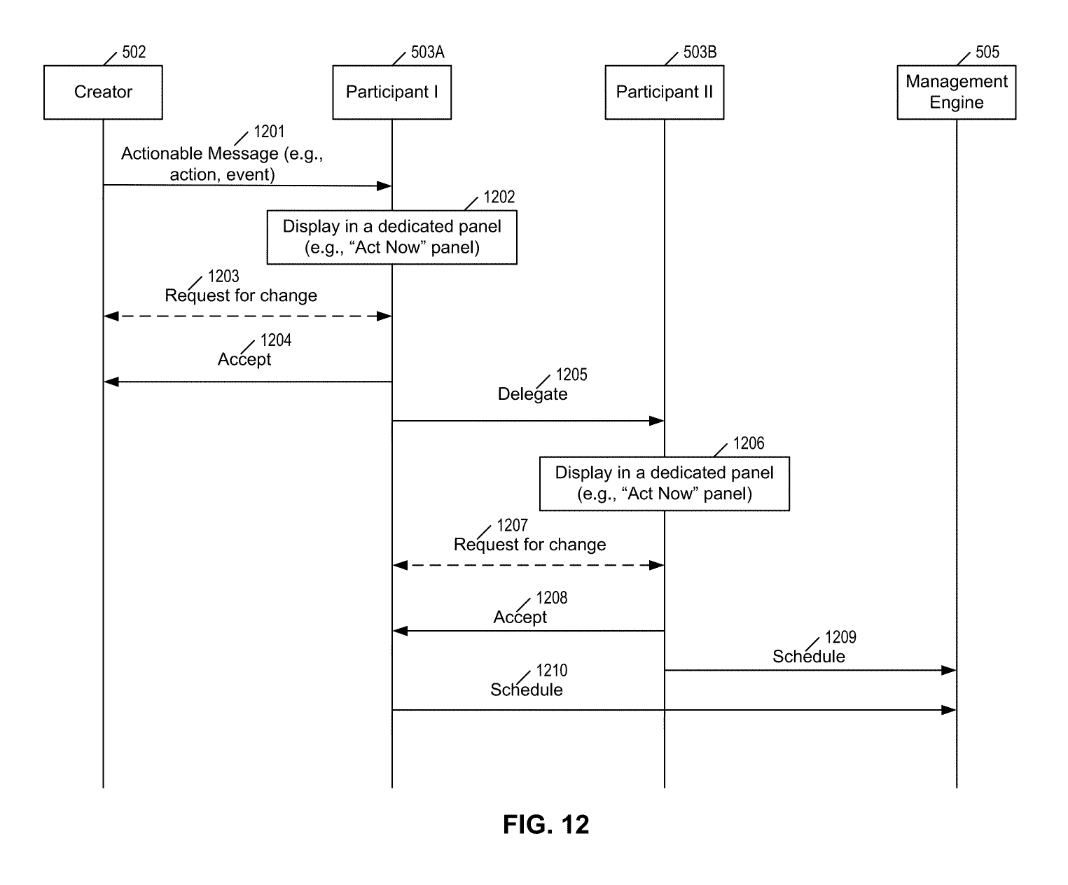

FIG. 12 is a processing diagram illustrating processing actionable messages according to one embodiment of the invention. The process may be performed by processing logic which may include hardware, software, or a combination thereof. For example, the process may be performed by participants 502-503 and management engine 505 of FIG. 5. Referring to FIG. 12, sender 502 composes an actionable message having a task or an event therein. The actionable message may include the information as shown in FIGS. 8A and 8B, dependent upon whether the actionable message includes a task or an event. At transaction 1201, sender 502 sends the actionable message to participant 503A, for example, by specifying a work activity participant as participant 503A in the actionable message.

At transaction 1202, the system detects that this is an actionable message instead of a regular message. The actionable message is displayed in a dedicated folder of a GUI of the integrated platform displayed at a display device of participant 503A. Participant 503A may exchange messages or chat with sender 502 requesting for changes of the task or event associated with the actionable message at transaction 1203. At transaction 1204, participant 503A accepts the action requested in the actionable message. At transaction 1205, participant 503A may delegate the task or event to another participant 503B, for example, by forwarding the same actionable message or sending a new actionable message to participant 503B. At transaction 1206, such an actionable message is again detected by the system and displayed in a dedicated folder. At transaction 1207, participants 503A and 503B may exchange messages or chat to request for change of the task or event. Once participant 503B accepts the delegation at transaction 1208, they can schedule with management engine 505 via transactions 1209 and 1210, respectively.

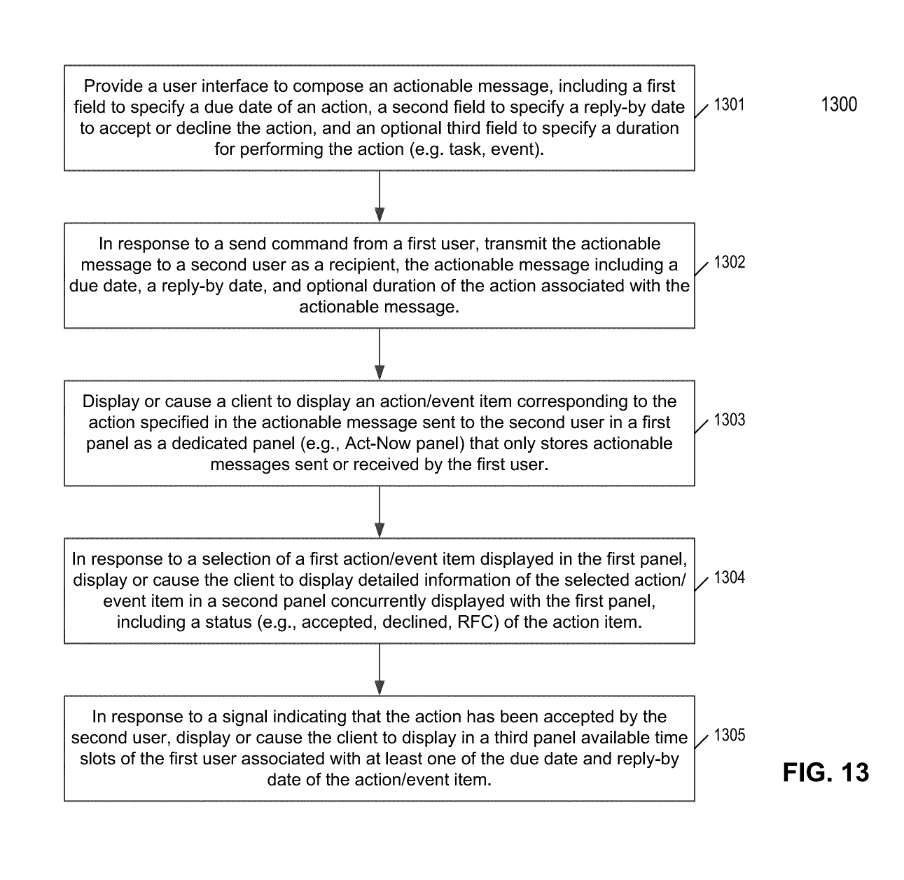

FIG. 13 is a flow diagram illustrating a process for processing actionable messages according to one embodiment of the invention. Process 1300 may be performed by processing logic which may include hardware, software, or a combination thereof. For example, process 1300 may be performed by manage engine 505 and user interface module 507, in conjunction with a client application of a client device. Process 1300 may be related to a sender of an actionable message. Referring to FIG. 13, at block 1301, processing logic provides a user interface to allow a sender to compose an actionable message. The user interface includes a first field to specify a due date, a second field to specify a reply-by date, and a third field to specify a duration required to perform a task or event. In response to a send command received from a first user, at block 1302, the actionable message is transmitted to a second user as a recipient. The actionable message includes a due date, reply-by date, and an optional duration of the action (e.g., task or event).

At block 1303, processing logic displays or causes a client application of the first user to display the action or event item in a first panel as a dedicated panel (e.g., Act Now panel) that only stores actionable messages sent or received by the first user. In response to a user selection of a first action/event item displayed in the first panel, at block 1304, processing logic displays or causes the client application to display detailed information of the selected action/event item in a second panel concurrently displayed with the first panel, including a status (e.g., accepted, declined, RFC) of the selected action item. At block 1305, in response to a signal indicating that the action/event has been accepted by the second user, processing logic displays or cause the client to display in a third panel available time slots of the first user associated with at least one of the due date and reply-by date of the action/event item.

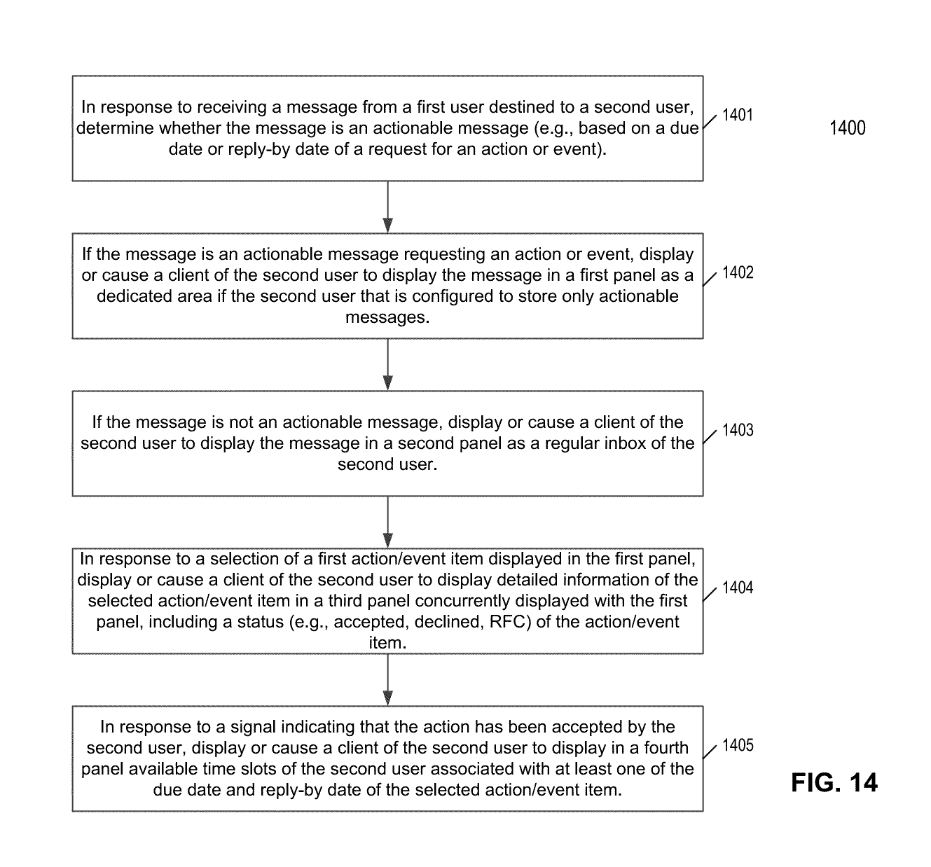

FIG. 14 is a flow diagram illustrating a process for processing actionable messages according to another embodiment of the invention. Process 1400 may be performed by processing logic which may include hardware, software, or a combination thereof. For example, process 1400 may be performed by manage engine 505 and user interface module 507, in conjunction with a client application of a client device. Process 1400 may be related to a recipient of an actionable message. Referring to FIG. 14, at block 1401, in response to receiving a message sent from a first user to a second user, processing logic determines whether the message is an actionable message (e.g., based on due date, reply-by date, duration, action/event identifier). If it is determined the message is an actionable message, at block 1402, processing logic displays or causes a client of the second user to display the message in a first display panel as a dedicated panel. Otherwise, at block 1403, the message is displayed in a regular inbox of the second user.

In response to a selection of a first action/event displayed in the first panel, at block 1404, the detailed information of the selected action/event is displayed in a third display panel concurrently displayed with the first panel, including a status (e.g., accepted, declined, or RFC) of the action event item. At block 1405, in response to a signal indicating that the action/event has been accepted by the second user, processing logic displays or causes the client of the second user to display in a fourth display panel available time slots of the second user associated with at least one of the due date and reply-by date of the action/event item.

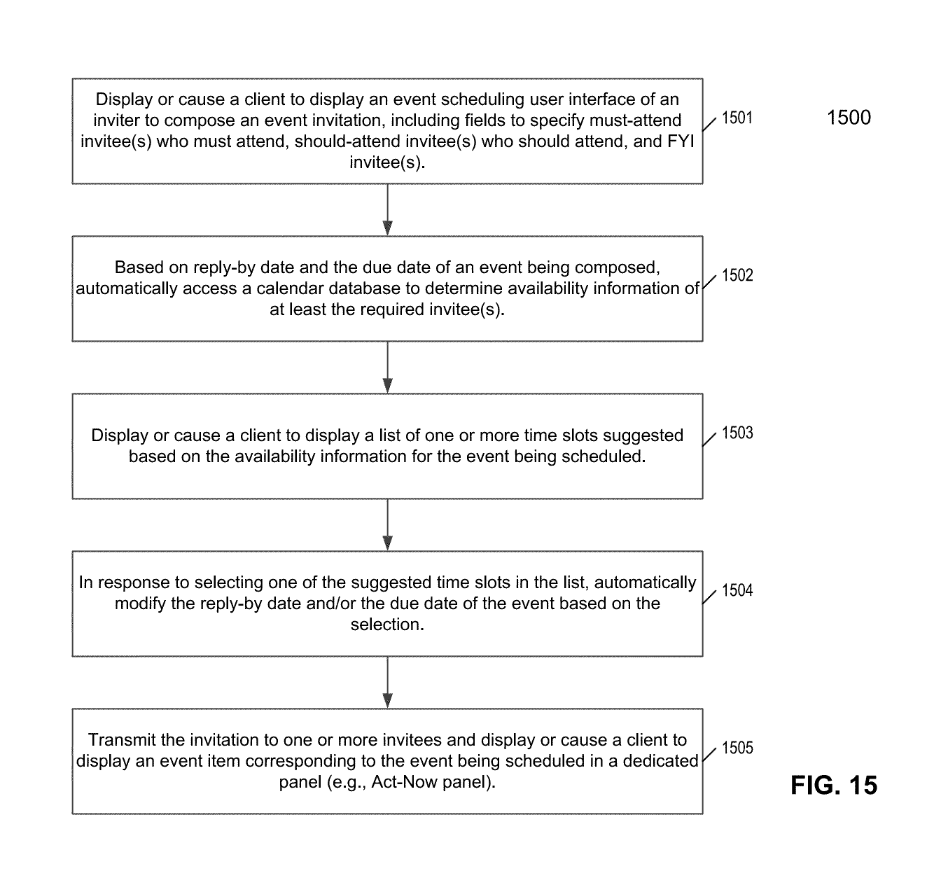

FIG. 15 is a flow diagram illustrating a process for processing actionable messages according to another embodiment of the invention. Process 1500 may be performed by processing logic which may include hardware, software, or a combination thereof. For example, process 1500 may be performed by manage engine 505 and user interface module 507, in conjunction with a client application of a client device. Referring to FIG. 15, at block 1501, processing logic displays or causes a client device to display an event scheduling user interface of an inviter to compose an event invitation. The user interface includes fields to specify required invitee(s) required to attend the event, invitee(s) who should attend the event, and invitee(s) that only be coped in the invitation. Based on the reply-by date and/or due date of the event being composed, at block 1502, processing logic automatically accesses a calendar database to determine availability information of at least the required invitee(s). At block 1503, a list of one or more time slots suggested by the system is displayed based on the availability information. In response to selecting one of the suggested time slots in the list, at block 1504, processing logic automatically modifies the reply-by date and/or the due date of the event based on the selection. At block 1505, the invitation is transmitted to the invitee(s) and the event is displayed in a dedicated display panel.

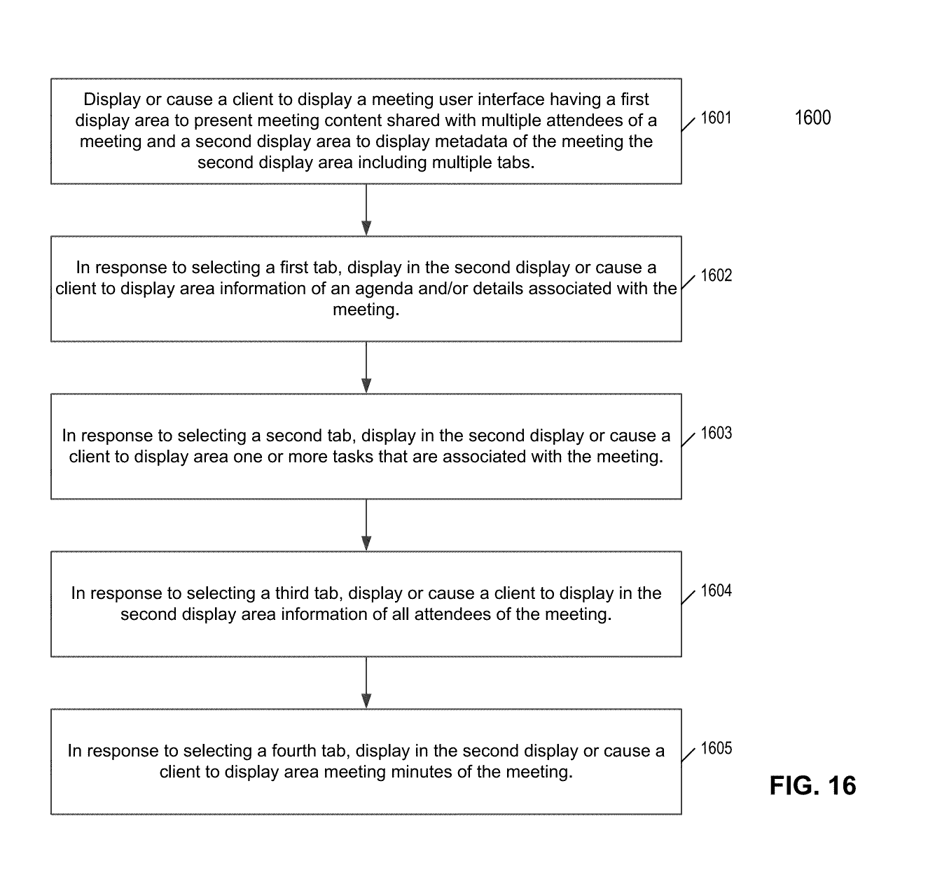

FIG. 16 is a flow diagram illustrating a process for content presentation in a collaboration environment according to one embodiment of the invention. Process 1600 may be performed by processing logic which may include hardware, software, or a combination thereof. For example, process 1600 may be performed by manage engine 505 and user interface module 507, in conjunction with a client application of a client device. Referring to FIG. 16, at block 1601, a meeting user interface of the integrated communication and collaboration platform is displayed. The meeting user interface includes a first display area to present meeting content shared with other attendees of the meeting and a second display area to display metadata of the presentation, where the second display area includes multiple tabs or pages. In response to a selection of a first tab, at block 1602, the agenda or detailed information of the meeting is displayed. In response to a selection of a second tab, at block 1603, one or more tasks associated with the meeting are displayed in the second display area. In response to a selection of a third tab, at block 1604, information of the attendees is displayed in the second display area. In response to a selection of a fourth tab, at block 1605, meeting minutes are displayed in the second display area.

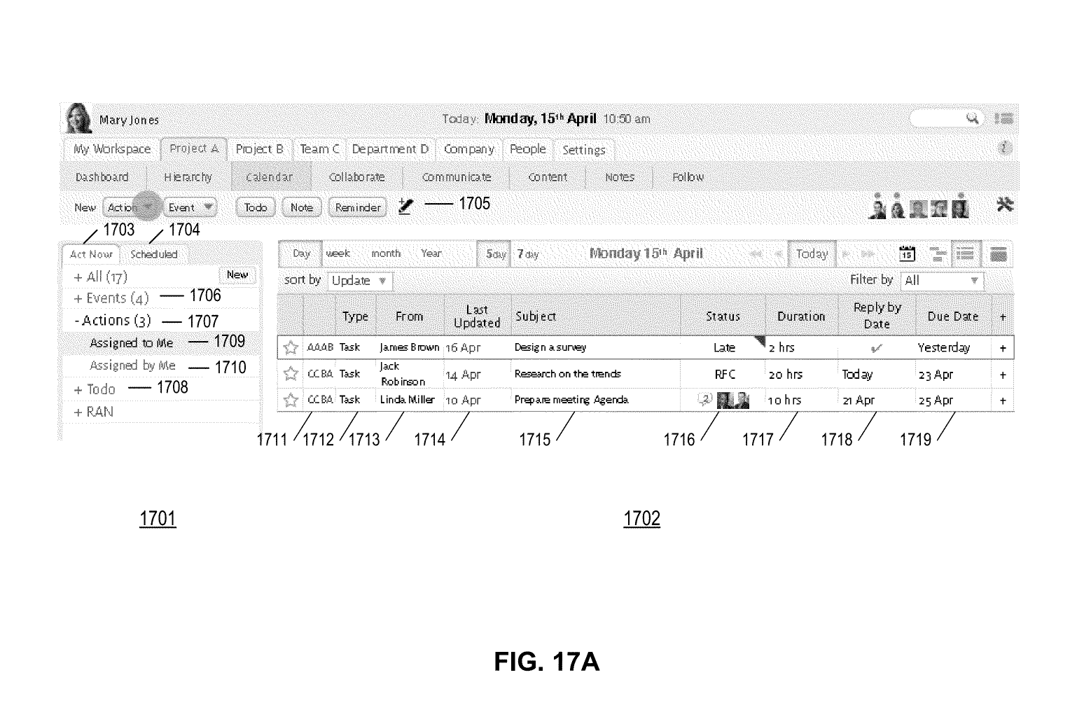

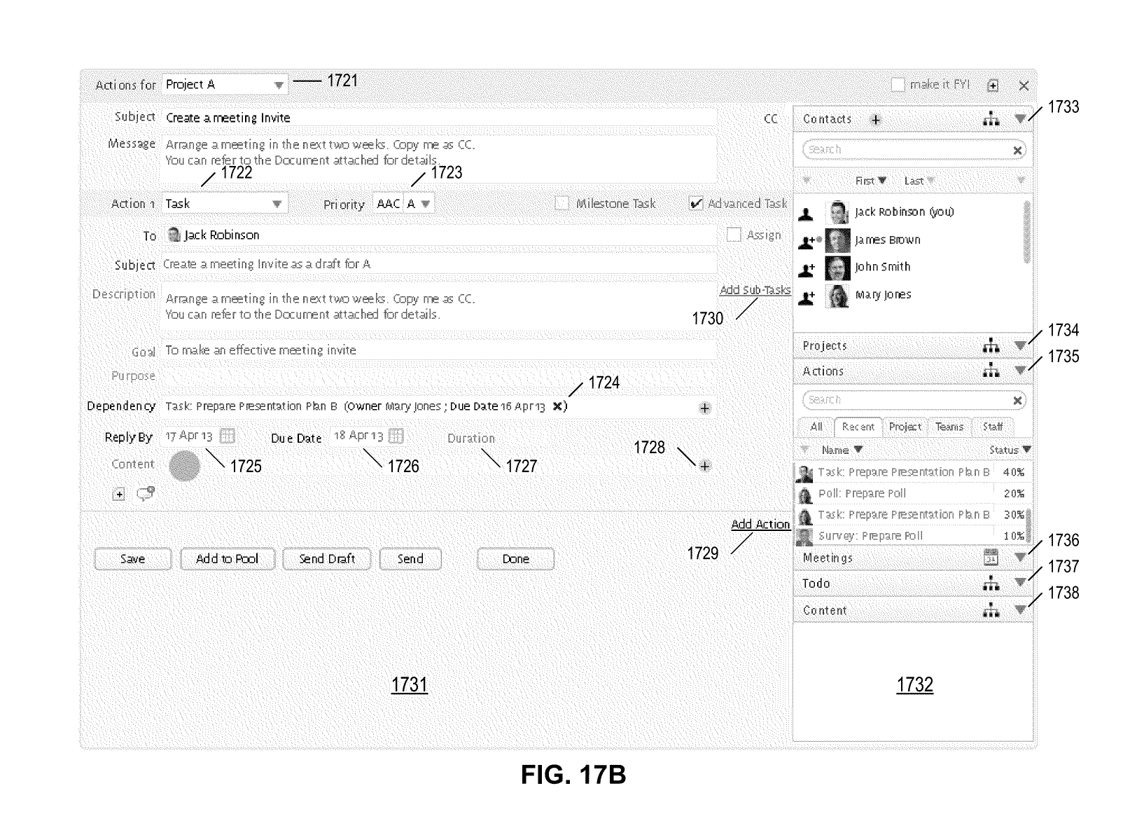

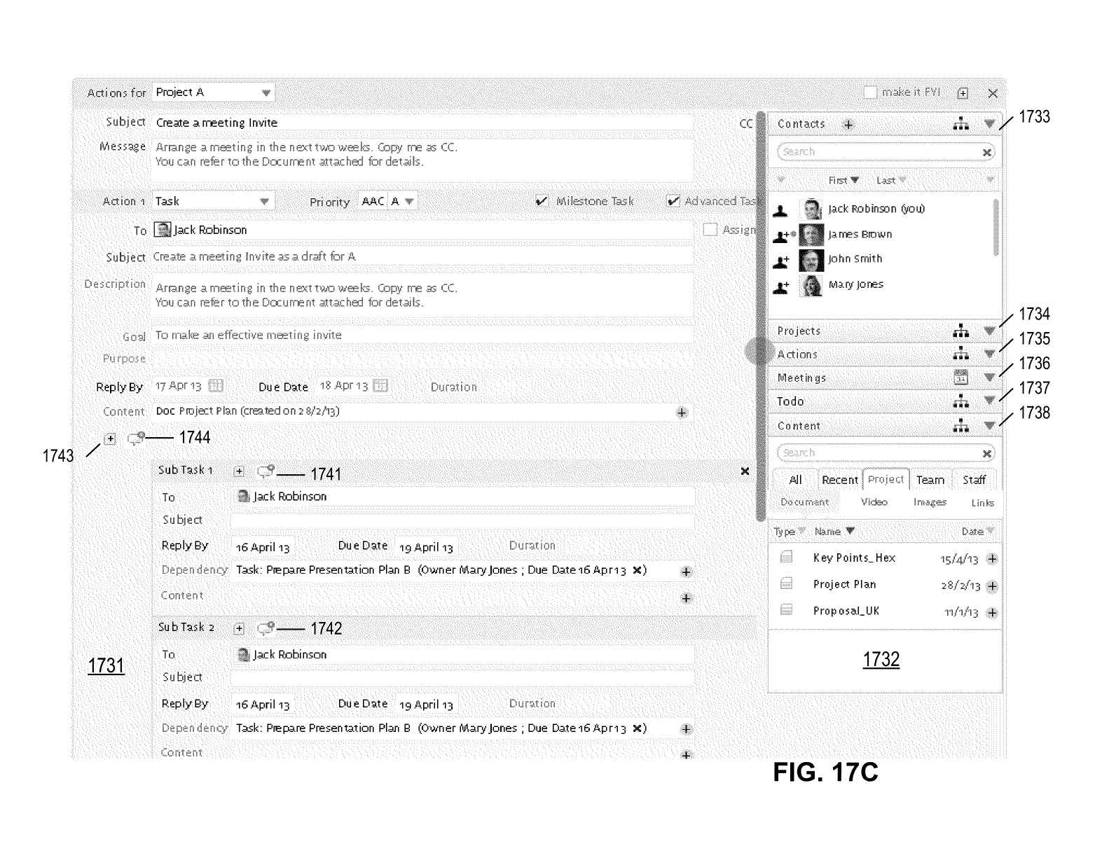

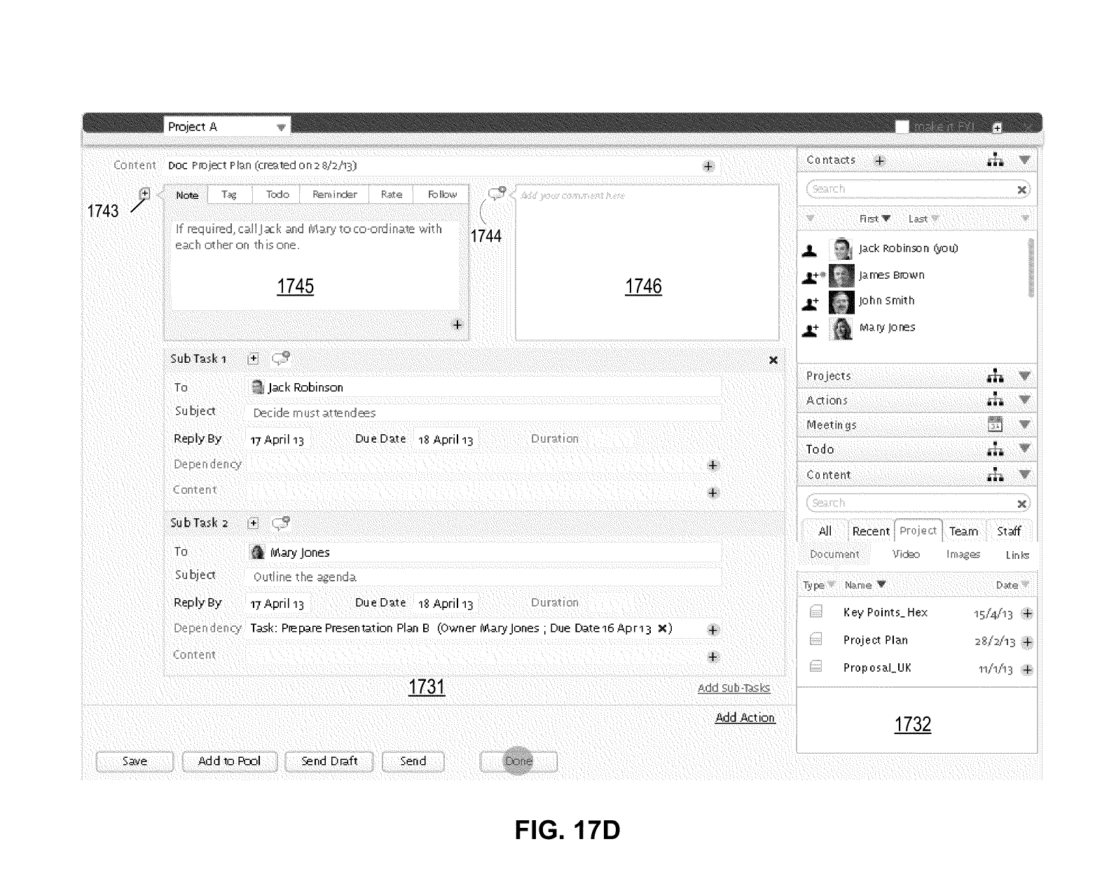

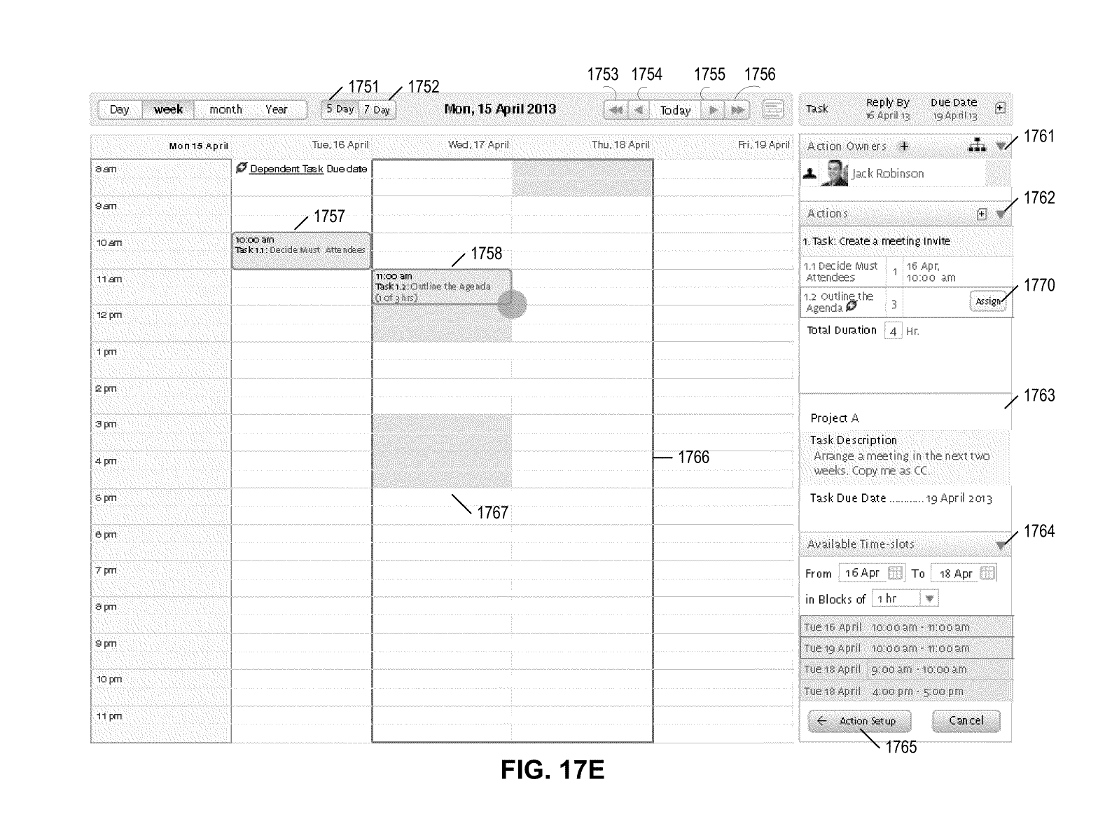

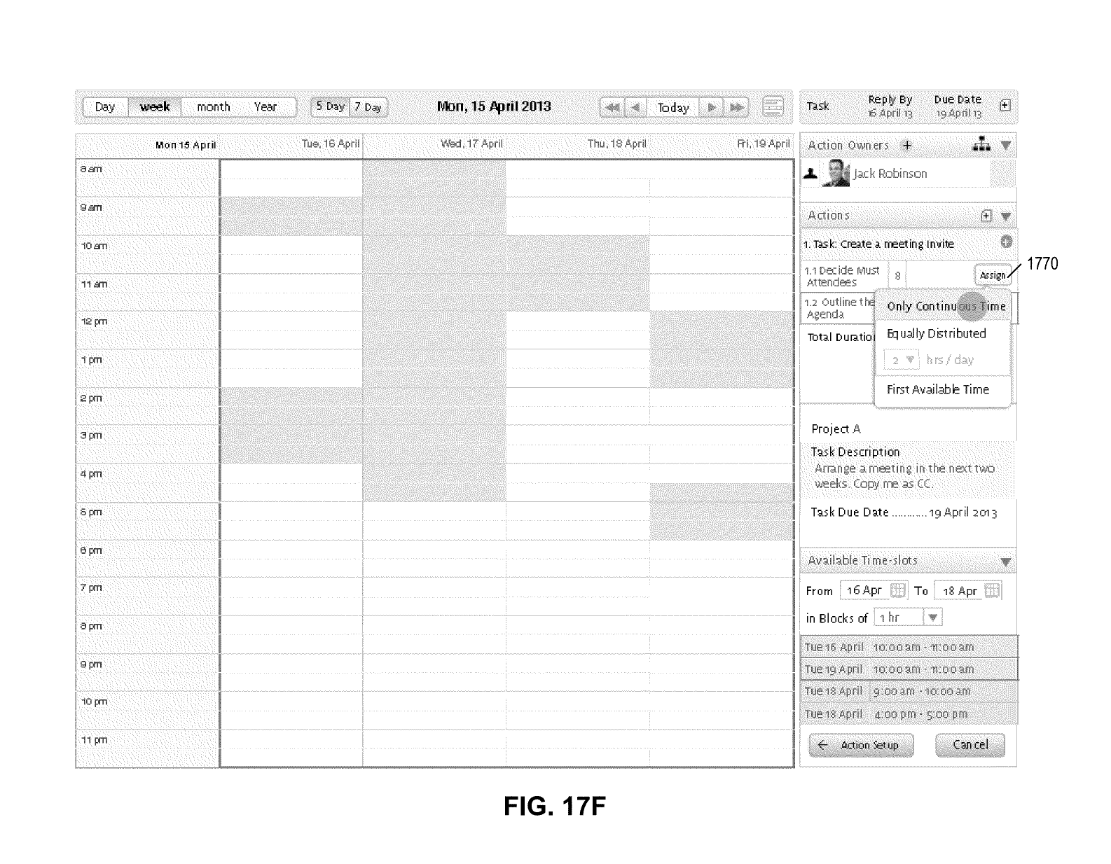

FIGS. 17A-17F are screenshots illustrating examples of graphical user interfaces of an integrated communication and collaboration platform according to some embodiments of the invention. The GUI pages may be generated and/or presented by interface module 507 of management server 501 and/or a client application of a client device such as client applications 508-509 of client devices 502-503 of FIG. 5. Referring to FIG. 17A, the GUI as shown may be displayed at a client device of a user when the user logs into the integrated communication and collaboration system. The user interface may be used to display any work related items in pages associated with the user including, in this example, workspace, projects, teams, department, company, people, and settings of the user. The user can select any of these pages to display detailed information of the selected page.

In this example, the user has selected a page associated with a project, “Project A.” In response to the selection of “Project A,” any information related to the selected project is displayed, in this embodiment, in multiple pages or tabs, including a hierarchy page to display a hierarchy structure of the selected project (e.g., parent or child projects associated with the selected project), calendar page to display calendar information of the selected project, a collaboration page to allow the user to conduct a collaboration session with other users concerning the selected project, a communication page to allow the user to send and receive messages or chat with other users, a content page to display or access any content or documents related to the selected project, notes entered for the selected project, and follow-up items associated with the selected project.

As described above, the integrated GUI can be used to create, send, and receive actionable messages. In one embodiment, the GUI of the integrated platform as shown in FIG. 17A includes a first display area (also referred to as a display panel) 1701 displaying a list of actionable message identifiers identifying the actionable messages sent or received by the current user. The GUI further includes a second display area 1702 to display detailed information of one or more actionable messages identified in the display area 1701. In one embodiment, display area 1701 includes multiple tabs or pages, including a first tab 1703 (e.g., “act now” page) for displaying pending actions associated with the user and a second tab 1704 (e.g., “scheduled” page) for displaying actions that have been scheduled.

In this example, tab 1703 has been selected and the action identifiers identifying pending actions are displayed in display area 1701. In one embodiment, the pending actions may be displayed based on the types of categories of the actions, such as, for example, events 1706, tasks 1707, and TODO 1708, etc. The tasks can be further categorized or divided into those sent by the user 1709 (e.g., “assigned by me” category) and those received by the user 1710 (e.g., “assigned to me” category). Each of the categories may further indicate a number of the associated action items and can be expanded or collapsed by clicking the corresponding plus (“+”) or minus (“−”) sign or icon. According to one embodiment, each of the actionable messages displayed in display area 1702 includes priority of the action 1711, type of the action 1712 (e.g., task, event, TODO), sender(s) of the action 1713, last update date 1714, subject of the action 1715, status of the action 1716 (e.g., accepted, declined, RFC, late), duration of the action 1717, reply-by date 1718, and due date 1719. The user can also create a new task, event, TODO item, note, and a reminder via respective buttons 1705, where the new items will be displayed display area 1701 under the corresponding folder or categories.

FIG. 17B shows a GUI page in which the user can compose an actionable message to be sent to one or more recipients. Referring to FIG. 17B, the GUI page may be displayed in response to a new command from the user, such as for example, an activation of one of buttons 1705 of FIG. 17A. The actionable message composing user interface includes various fields to allow a user as a sender to specify certain information or metadata of the actionable message. The user interface includes field 1721 to specify which of the project or other entities the new action or event of the actionable message is associated with. In this example, the new action or event is associated with “Project A” that when the message is sent, the actionable item will be displayed under “Project A” tab as shown in FIG. 17A.

In one embodiment, the user can specify the type of the action (e.g., task, event) in field 1722 and its priority in field 1723. The user can further link another item such as project (e.g., parent project) with the current action in field 1724. In addition to those standard fields such as subject, description, etc., the user can specify a reply-by date in field 1725, a due date in field 1726, and a duration of the action in field 1727. The user can also attach content or documents by clicking button or icon 1728, which may display browsing window to allow the user to browse and select a file to be attached. The user interface further includes a button or control 1729 to add an additional action (e.g., task, event, TODO item) to the actionable message. The user can also add a subtask by clicking button or control 1730.

According to one embodiment, the actionable message being composed is displayed in a main window or panel 1731. In addition, other information can be displayed in a sidebar window or panel 1732, including contacts 1733, projects 1734, actions 1735, meetings 1736, TODO 1737, and content 1738. Each of these subpanels 1733-1738 can be expanded or collapsed by clicking the corresponding triangle icon or control. In this example, contacts window 1733 and actions window 1735 are expanded, while the rest of the windows are collapsed. The user can drag and drop a recipient of the actionable message from contacts window 1733 into the TO field and the underlying logic (e.g., action manager, event manager) automatically fills in the proper email address of the recipient. In one embodiment, the actions window 1735, when expanded, includes multiple tabs or pages, such as recent actions (including the status of the actions), project, teams, etc. The projects window 1734, when expanded, displays one or more projects associated with the current user. The meetings window 1736, when expanded, displays the meetings associated with the current user. The TODO window 1737, when expanded, displays the TODO items associated with the current user. The content window 1738, when expanded, displays the files that the user can select and attach to the actionable message being composed.

Referring now to FIG. 17C, which may be displayed in response to a command to add a subtask, such as, for example, button 1730 of FIG. 17B. In this example, the user has added two subtasks 1741-1742. Similar to the user interface as shown in FIG. 17B, the user can access sidebar windows 1733-1738 to access information concerning recipients, projects, actions, meetings, TODO, and content, respectively. In this example, the user accesses the content window 1738, which displays the content or files associated with a particular project. The user can drag and drop a file into the main window of the actionable message to be attached therein.

According to one embodiment, the user can also glue another item to the actionable message by clicking icon or button 1743 or add comments by clicking icon or button 1744 as shown in FIG. 17D. Referring to FIG. 17D, when button 1743 is activated, a glue window 1745 is displayed to allow a user to select and specify additional information, such as notes, tag, TODO item, reminder, rate, and follow. Alternatively, the user can enter some comments in comments window 1746 by clicking button 1744.

FIG. 17E shows a user interface to allow a user to schedule an action (e.g., task, event, TODO, reminder) according to one embodiment. In this example, a calendar view is displayed, for example, in response to an activation of tab 1704 of FIG. 17A. Referring to FIG. 17E, similar to other calendar tools, the calendar view can be displayed in day, week, month, or year granularity. When the calendar view is displayed on a weekly basis, according to one embodiment, the calendar view can be displayed in either 5-day mode or 7-day mode by clicking buttons 1751 and 1752, respectively. When button 1751 is activated, the calendar view will be displayed in 5 days per session, and when button 1752 is clicked, the calendar view will be displayed in 7 days per session.

According to another embodiment, the user interface provides a fast forward button 1756 and fast backward button 1753 to allow a user to scroll the calendar view forward and backward for the entire page dependent upon the current view. For example, when the current view is a weekly view, the activation of button 1756 will advance the calendar view for 5 or 7 days dependent upon whether the current calendar view is in a 5-day mode or 7-day mode. Similarly, if the calendar view is in a monthly or yearly view, the activation of button 1756 will advance the calendar view by a month or a year, respectively. Furthermore, according to one embodiment, the user interface further provides a second forward button 1754 and backward button 1755 that are only available in a daily view or weekly view. When buttons 1754-1755 are activated, the calendar view will be scrolled forward or backward by one day only.

According to one embodiment, within the calendar view displayed in a main display area, a sidebar window is displayed having variety information that is convenient to schedule an event or action. In one embodiment, the sidebar window includes action owners window 1761, actions window 1762, projects window 1763, and available time slots window 1764. Actions window 1762 lists the actions that have been scheduled or to be scheduled with the potentially selected time slots in the current calendar view, such as, for example, tasks 1757 and 1758 as indicated or highlighted in the calendar view. Action owner window 1761 displays user identifiers of the action owners of the actions listed in actions window 1762. Projects window 1763 displays a list of projects associated with the actions.

In addition, available time slot window 1764 displays a list of time slots that can be assigned to the action or actions. In one embodiment, based on the duration and due date of the action, the available time slots are automatically determined in available time slot window 1764 to allow the user to select, for example, by drag and drop the time slot(s) into the calendar view for scheduling. That is, in response to a scheduling command from the user, the calendar manager accesses the calendar information of the user to determine the available time slots of the user. In another embodiment, the calendar manager may also determine the available time slots of the potential recipients if the recipients have been specified. In addition, the calendar view also indicates the available time slots, such as time slot 1767. In this example, the user has selected time slots 1757 and 1758 for the action. However, the user can also change his or her mind by selecting time slot 1767, for example, by drag and drop of items 1757-1758 into time slot 1767.

Furthermore, the user can also assign a time slot based on a set of rules by clicking assign button 1770 and in response, the calendar manager can automatically select an available time slot to be associated with the action, for example, based on only continued time, equally distributed time, and first available time as shown in FIG. 17F. Alternatively, the action may be automatically scheduled without user intervention based on a set of scheduling rules configured by the user. For example, the user may specify in its scheduling preferences that if an actionable message is received from a predetermined set of senders (e.g., supervisors, managers, boss), the action will be automatically scheduled.

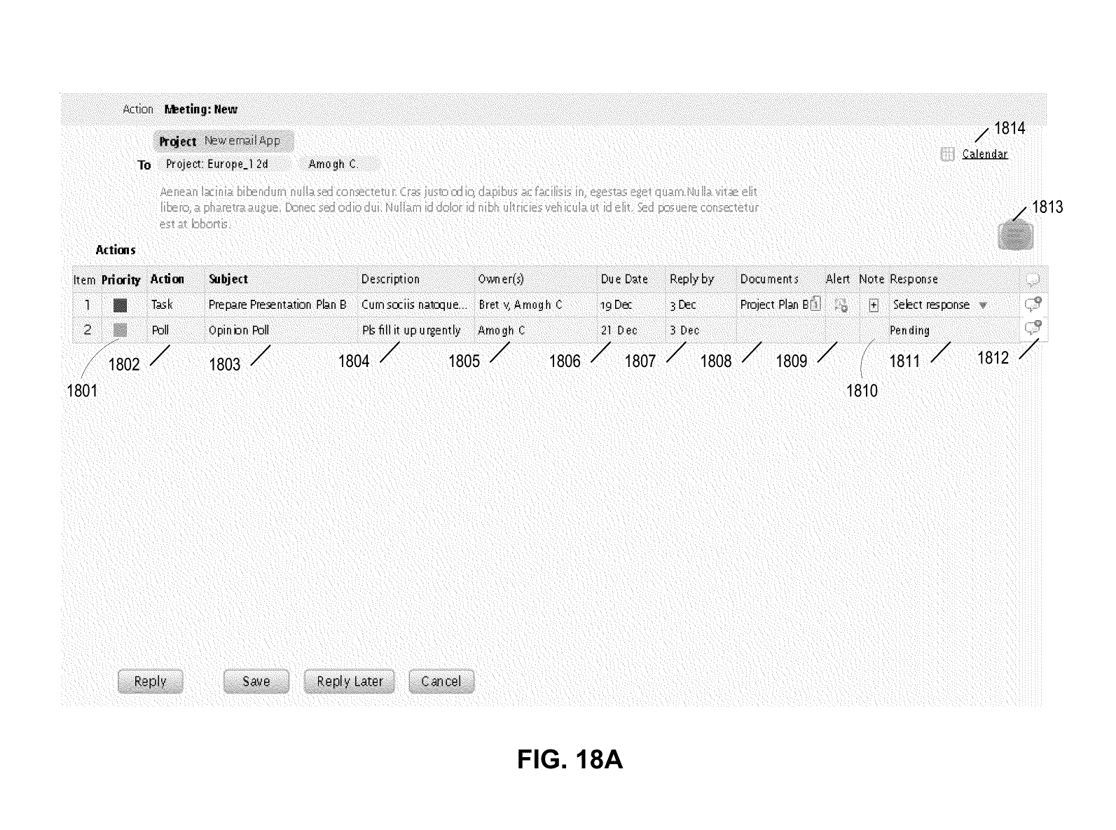

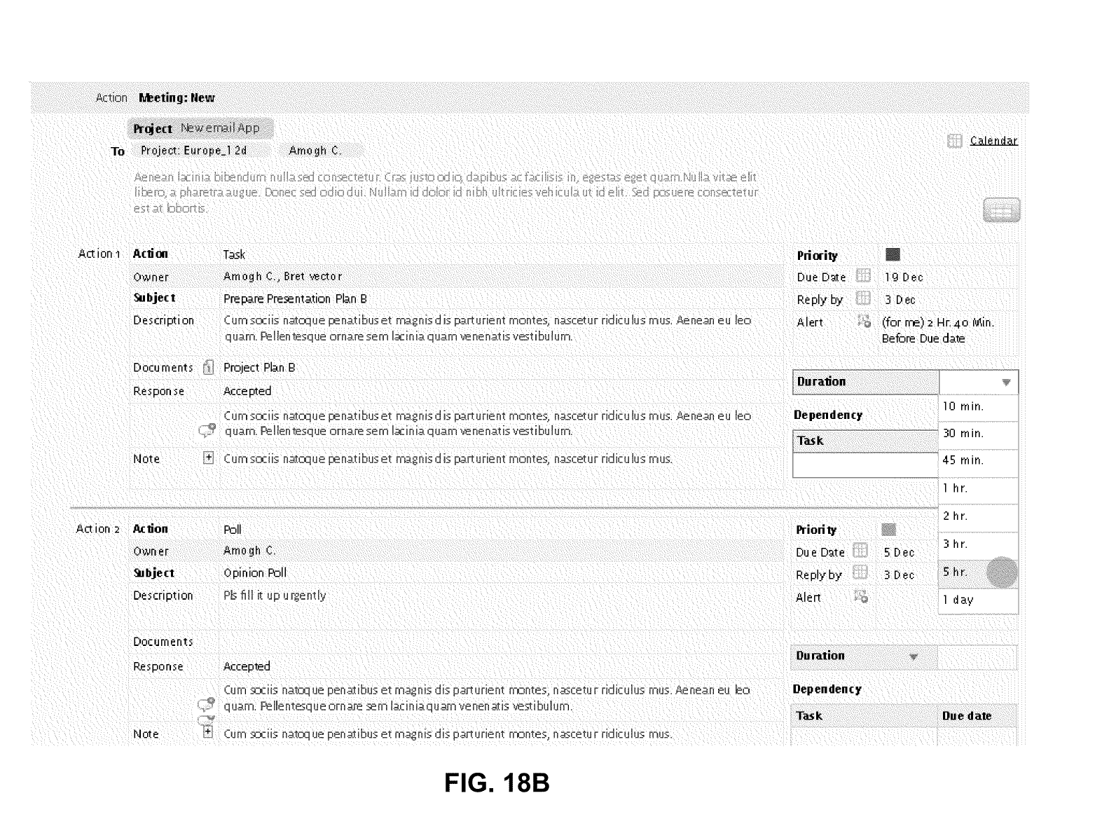

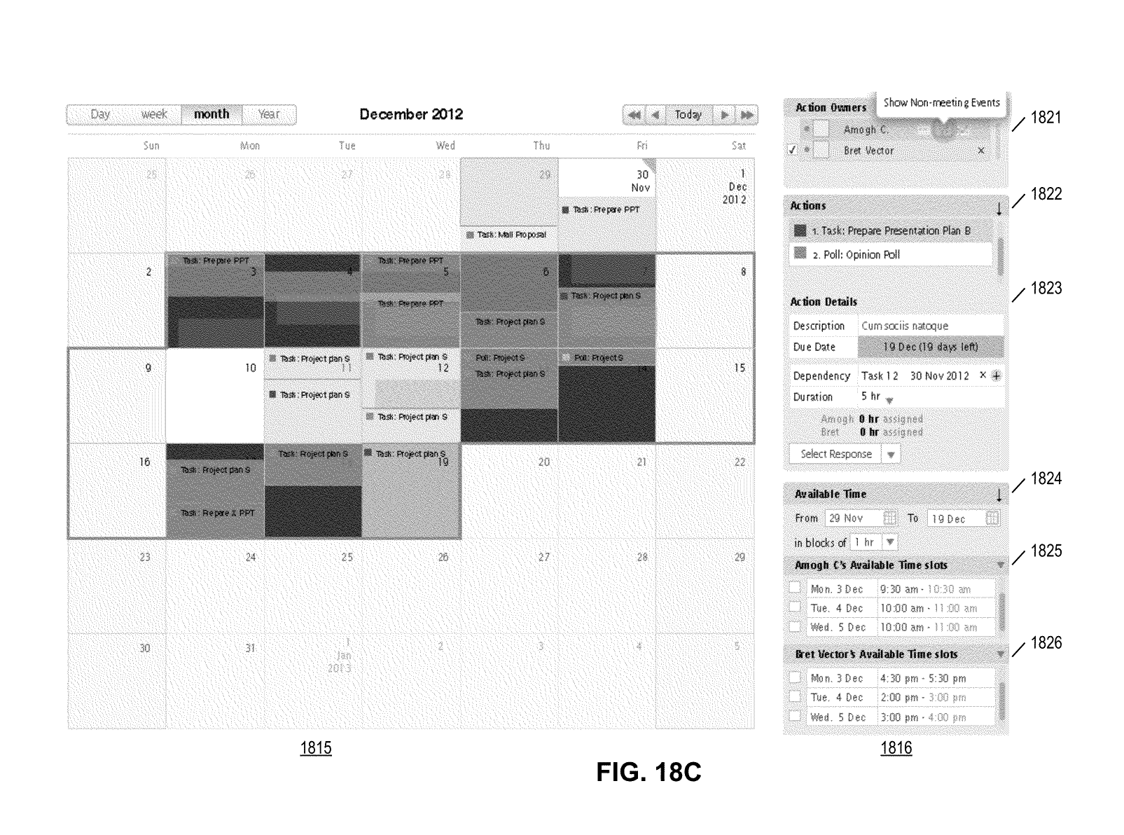

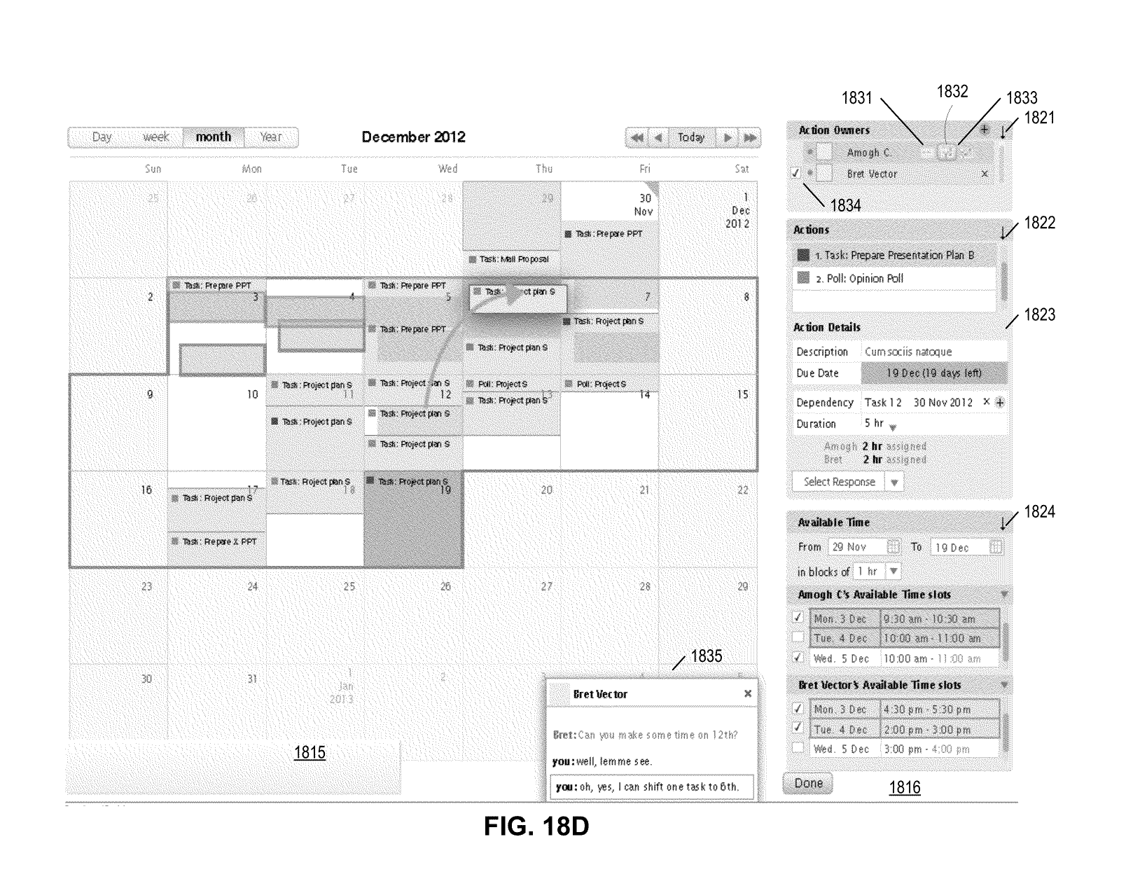

FIGS. 18A-18D are screenshots illustrating examples of graphical user interfaces of an integrated communication and collaboration platform according to some embodiments of the invention. The GUI pages may be generated and/or presented by interface module 507 of management server 501 and/or a client application of a client device such as client applications 508-509 of client devices 502-503 of FIG. 5. Referring to FIG. 18A, the GUI is shown from a recipient's point of view, which may be presented from the GUI page as shown in FIG. 17A. In this example, a list of actionable messages associated with a current user as a recipient is displayed. Each actionable messages is displayed with priority 1801, type of action 1802, subject 1803, brief description 1804, owners of the actions 1805, due date 1806, reply-by date 1807, attached document 1808, alert 1809, note 1810, response or status 1811, and comments 1812. The user can respond via field 1811, set up an alert via field 1809, and adding comments via field 1812. In one embodiment, the user can also view the details of the actionable messages by clicking button or control 1813, from which the detailed information of the actionable messages is displayed as shown in FIG. 18B. Referring to FIG. 18B, from the sidebar window of each of the displayed actionable messages, the user can specify the duration of the action, as well as other information.

FIG. 18C shows a calendar view to allow a user to schedule an action received from another user such as a work activity creator, which may be displayed in response to an activation of calendar button 1814 of FIG. 18A. In one embodiment, the GUI as shown in FIG. 18C is used to schedule an action (e.g., task or event) received by the current user. In addition to displaying the calendar view in main display area or window 1815, a sidebar window 1816 is displayed, including action owner window 1821, action window 1822, action detail window 1823, and available time window 1824. Action owner window 1821 display owners of the action being scheduled. In this example, there are two owners. The action window 1822 displays a list of actions associated with the current user. The user can schedule any of the actions listed in window 1822 by specifically selecting the action.

When any of the actions is selected in window 1822, the detailed information of the selected action is displayed in action detail window 1823, including description, due date, dependency, duration. From the detail window 1823, the user can respond to the outstanding action by accepting, declining, or requesting for change, etc. In addition, the available time slot window 1824 displays the available time slots for each of the participants of the action. In this example, there are two participants shown in action window 1821. Accordingly, the available time slot window 1824 shows the available time slots 1825 and 1826 for both participants. The user can select or drag and drop the time slots into the main display area 1815 for scheduling.

According to another embodiment, for each of the participants, the user can selectively display certain calendar information of the participant as shown in FIG. 18D. Referring now to FIG. 18D, for each of the participants displayed in action owner window 1821, the user can click any of the filtering buttons 1831-1833 to selectively display certain types of calendar information of the associated participant. In one embodiment, when the user move its cursor over a participant displayed in window 1821, buttons 1831-1833 will appear to allow the user to activate. When button 1831 is activated or clicked, according to one embodiment, only the available time slots of the associated participant is displayed in main calendar view 1815 and/or available time slot window 1824 for that participant. When button 1832 is activated or clicked, the non-meeting events are shown and when button 1833 is activated or clicked, all events are shown for that participant. In addition, according to a further embodiment, the user can initiate a live communication session 1835, such as a chat session, to discuss the action with another participant, by clicking a corresponding button 1834 of that participant. The live communication session is displayed inline while the calendar view 1815 and sidebar window 1816 are concurrently displayed.

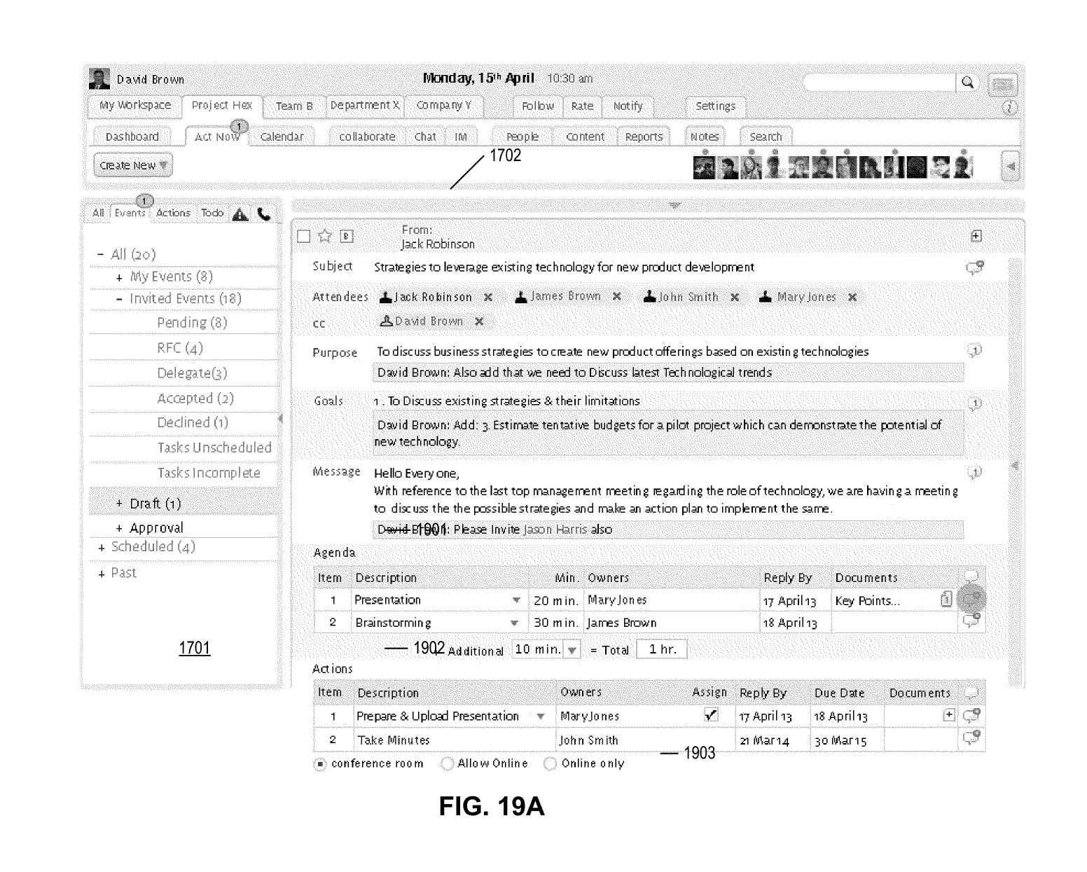

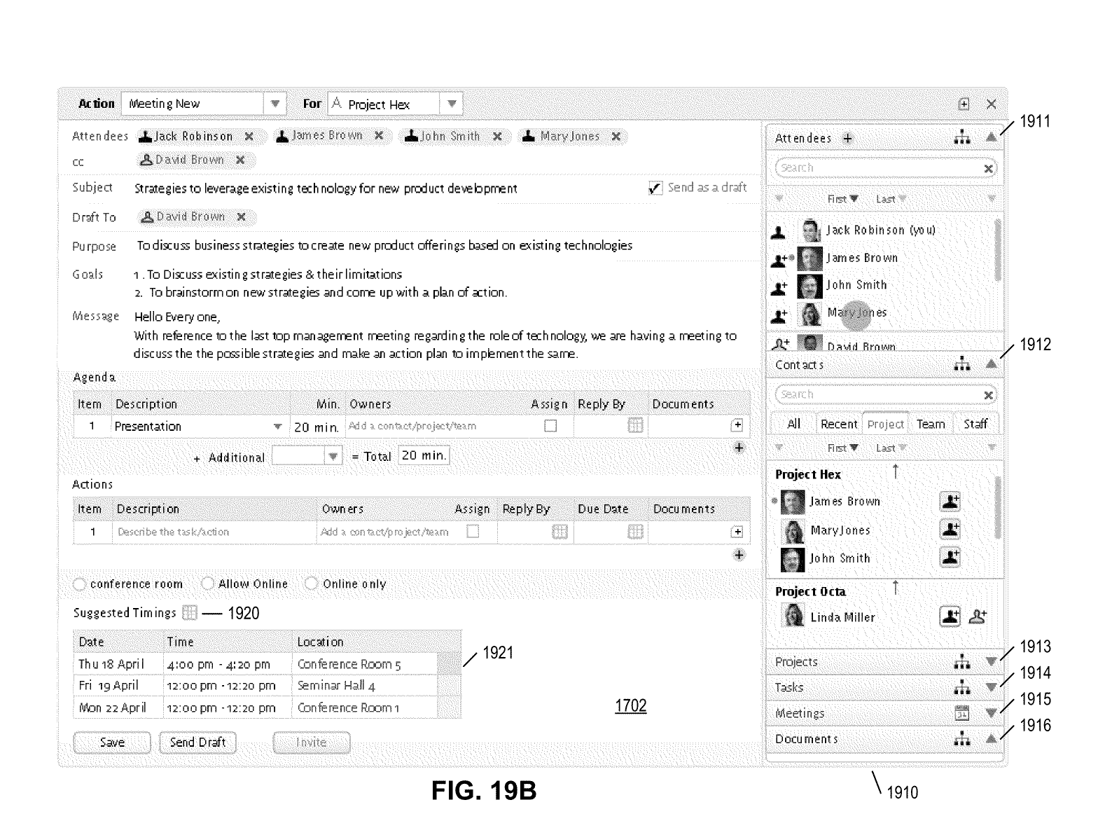

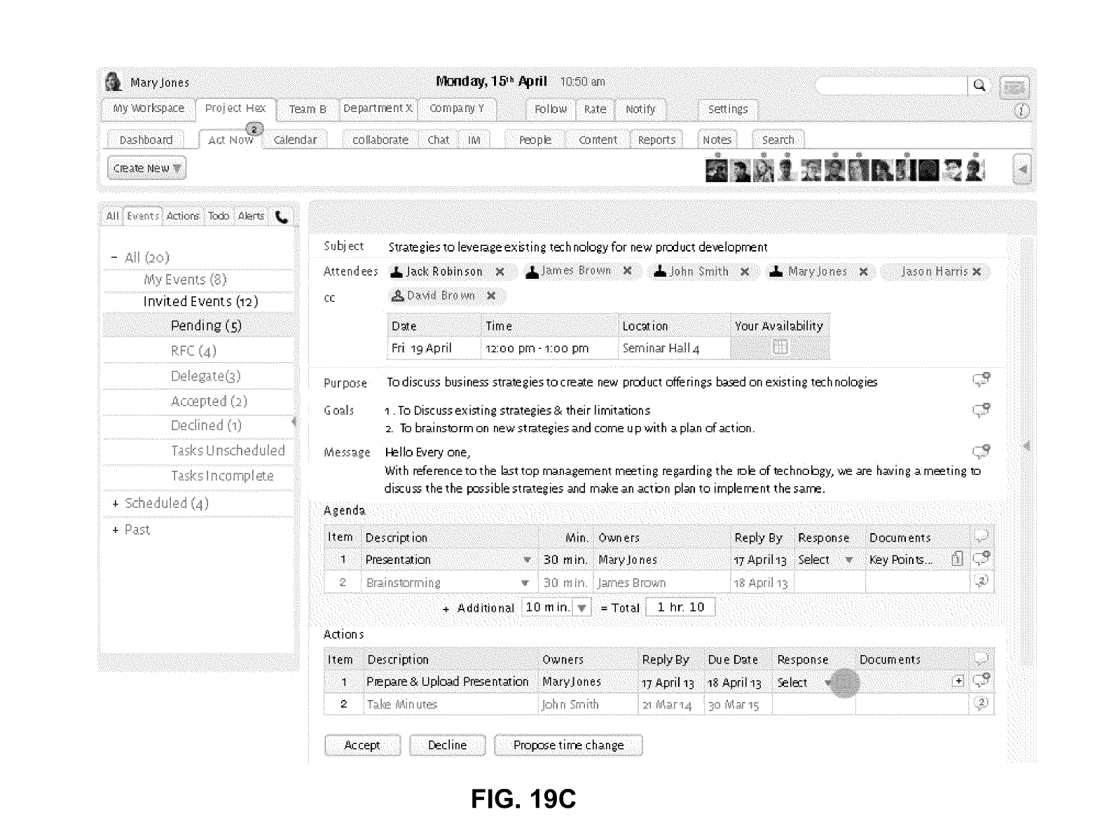

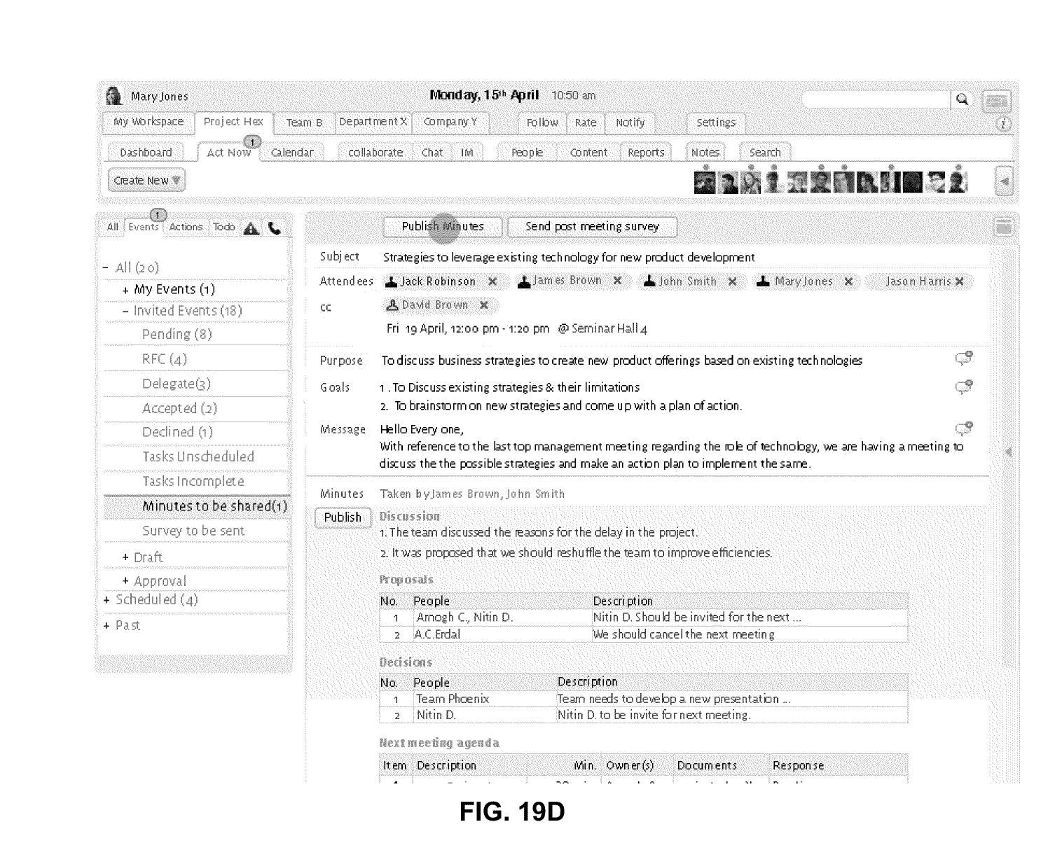

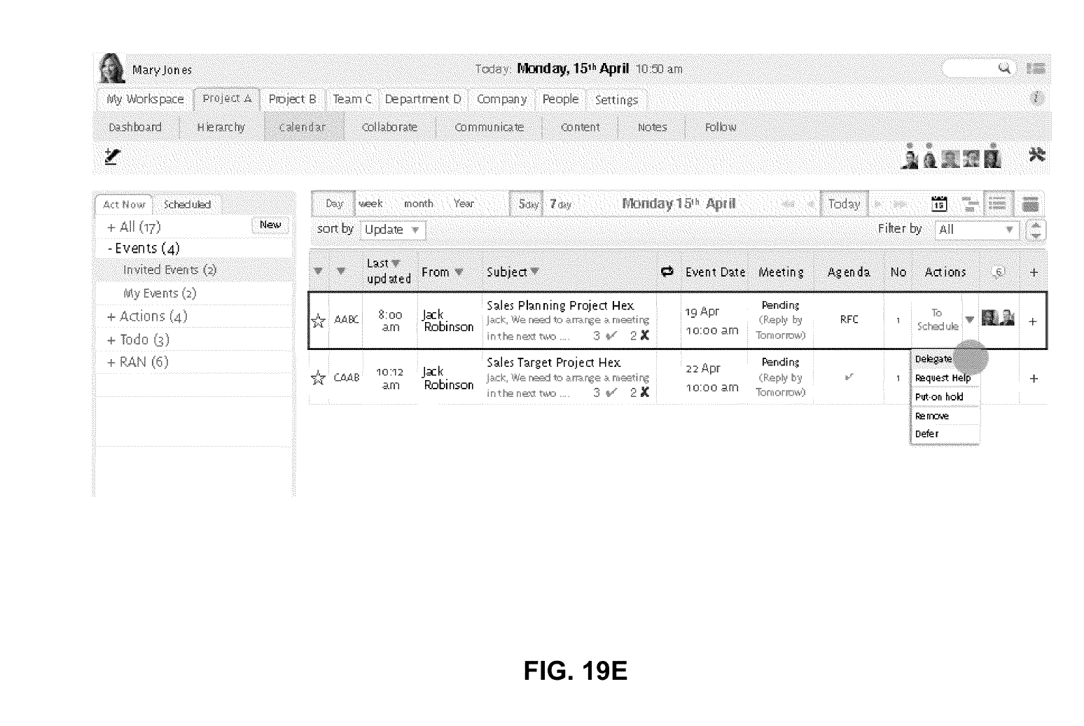

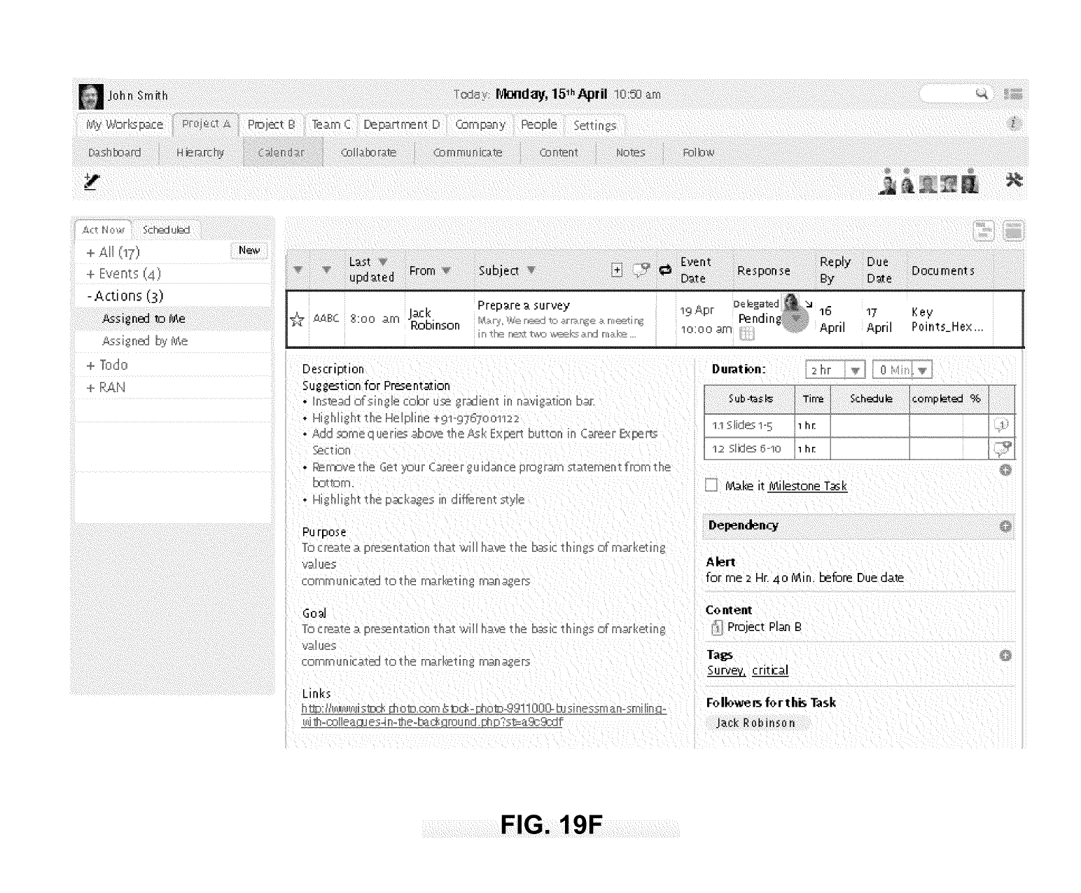

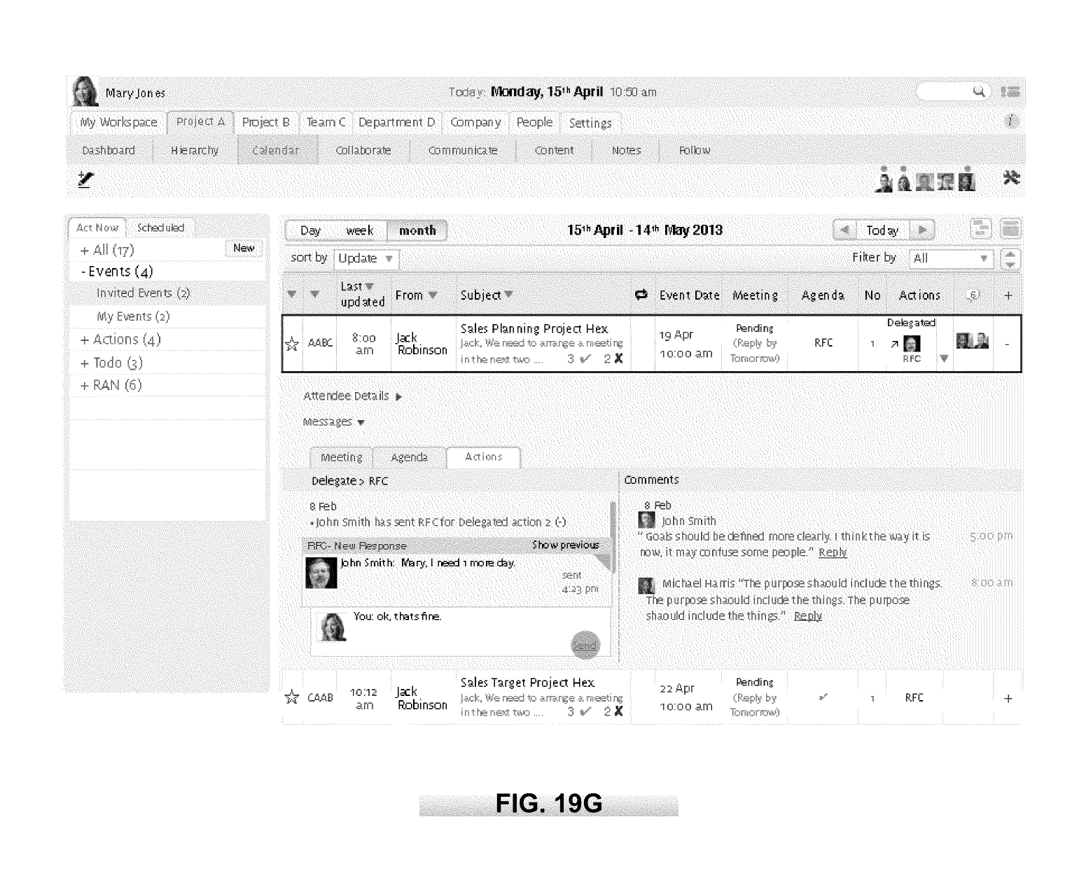

FIGS. 19A-19G are screenshots illustrating examples of graphical user interfaces of an integrated communication and collaboration platform according to some embodiments of the invention. The GUI pages may be generated and/or presented by interface module 507 of management server 501 and/or a client application of a client device such as client applications 508-509 of client devices 502-503 of FIG. 5. Referring to FIG. 19A, the user interface is utilized by a user to initiate an event such as a meeting by composing an actionable message having the event specified therein. The user interface includes various fields allowing the user to specify subject, attendees (e.g., required attendees, should-attend attendees, FYI attendees), purpose, goals, and a brief message.

In addition, according to one embodiment, the user interface further includes agenda field 1901 to allow the user to specify one or more agendas, including how long the presentation of the agenda will last, the presenter, reply-by date, and any documents attached thereto. The user interface further includes action field 1902 to specify one or more tasks attached to the event, including description, owners of the tasks, assignment of the tasks, reply-date, due date, and attachments. The user can also specify the location or place 1903 of the event, either in person, online, or both.

The event being schedule can also be displayed in a full page as shown in FIG. 19B. Referring to FIG. 19B, in addition to display the detailed information of the event in the main display area 1702, a sidebar window 1910 is also displayed as described above, including attendee window 1911 listing all the attendees, contact window 1912 listing contacts of the user, project window 1913 listing projects associated with the user, task window 1914 listing tasks associated with the user, meeting window 1915 listing meetings associated with the user, and document window 1916 listing files associated with the user. The user can associate or link any of the information displayed in sidebar window 1910 to the event being composed in main display area 1702.

According to another embodiment, based on the due date and/or reply date, the system may access the calendar information of the attendees to determine or suggest the most appropriate time slots and the location of the event via button or control 1920. For example, the user can click button 1920 to query the most appropriate time slots and location 1921 suggested by the system. The user can simply select the time slot and location from the suggested ones 1921 to propose the event.

FIG. 19C shows a graphical user interface of event received by a recipient according to one embodiment of the invention. Referring to FIG. 19C, the user receives an invitation from an originator (e.g., user of FIG. 19A) and the user interface displays the detailed information of the invitation. The user can accept, decline, or propose change by clicking the corresponding buttons. After, the event has been conducted, a user can access the event minutes as shown in FIG. 19D according to one embodiment. Referring to FIG. 19D, the user can send the event minutes to the rest of the attendees. The minutes may include discussion during the event, proposals, decisions, and/or next meeting agenda, etc. The user can also publish the minutes in a predetermined community by clicking the publish button. FIG. 19E shows a user interface in which a user, as a delegator, can delegate an action or assignment to another user. FIG. 19F shows a user interface in which a user, as a delegatee, receives and respond to a delegation of an action. FIG. 19G shows a user interface in which a delegatee initiate a live communication session with a delegator to request for change of an assignment or delegation, while the assigned action is displayed in a main display area.

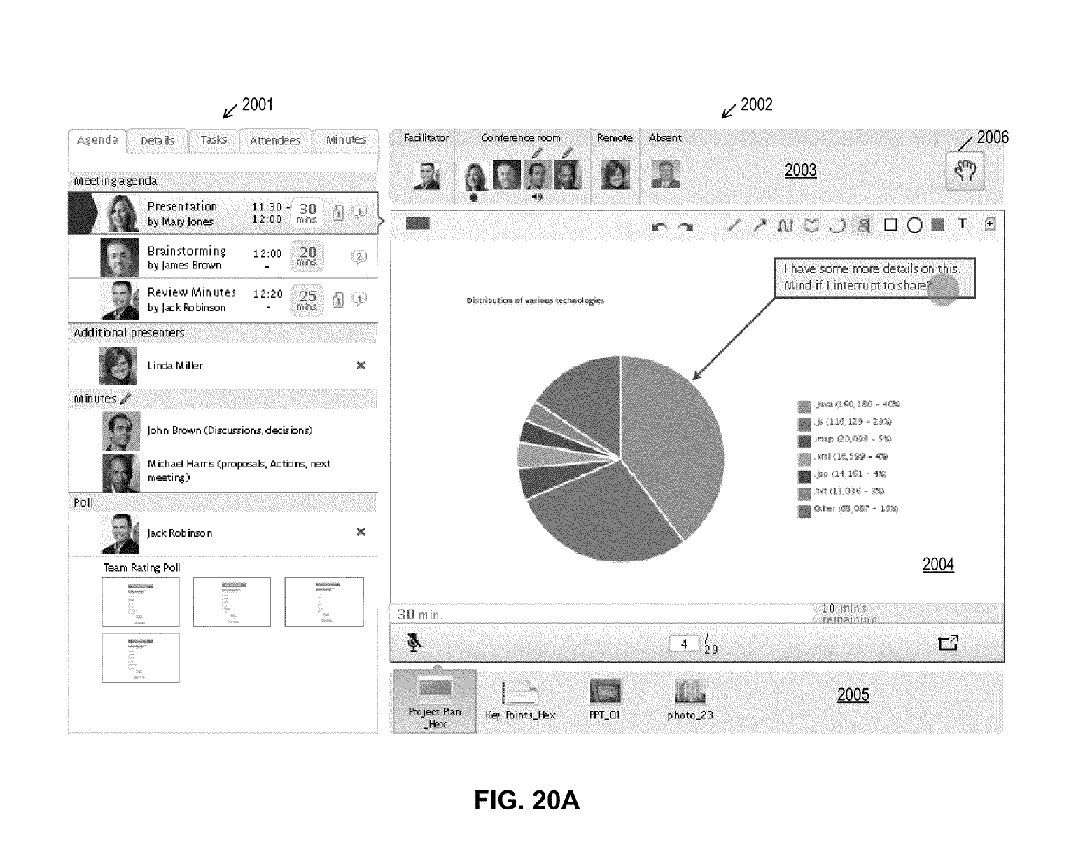

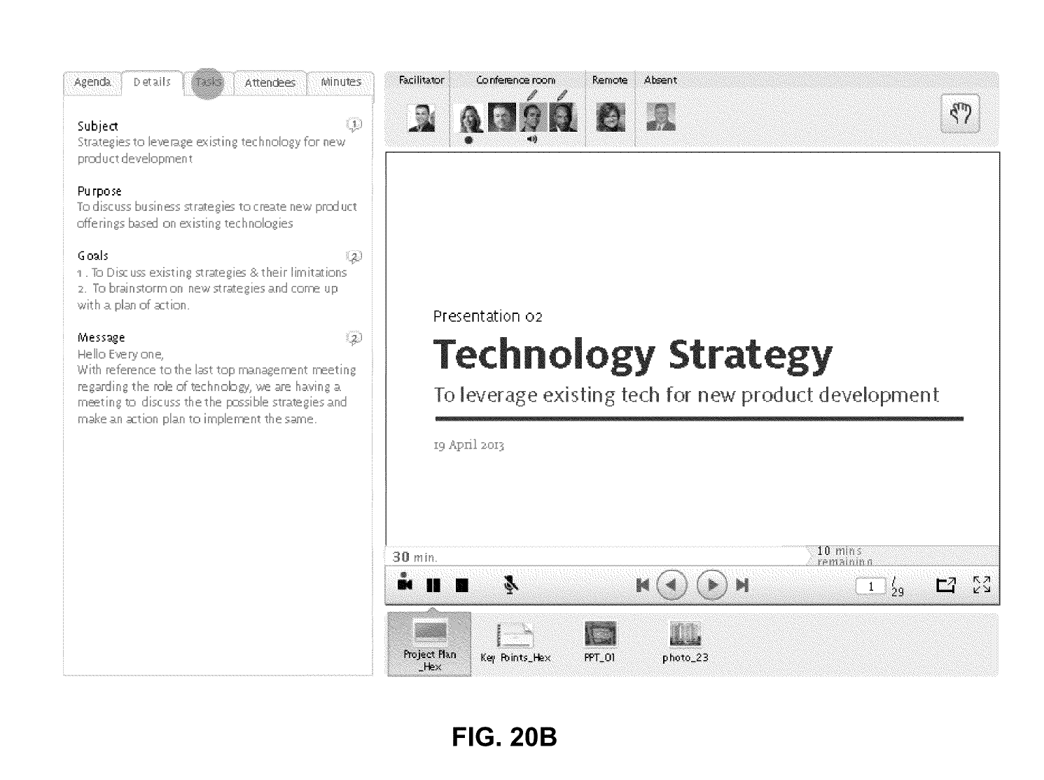

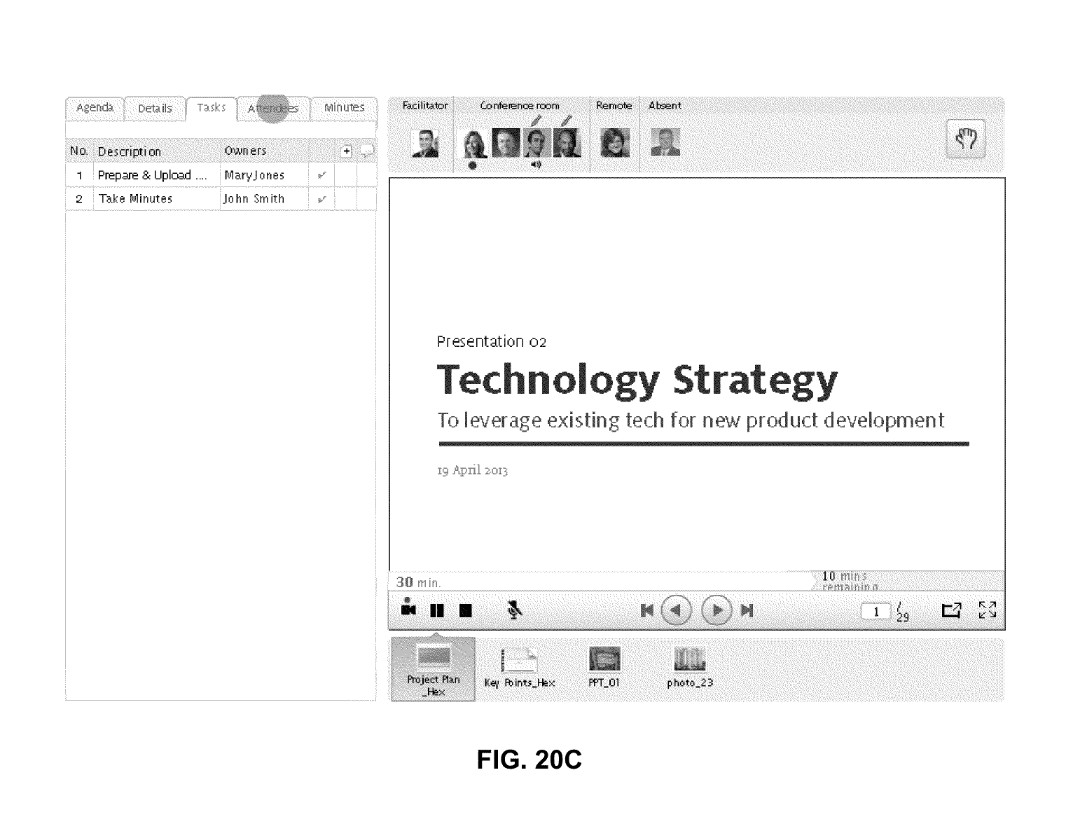

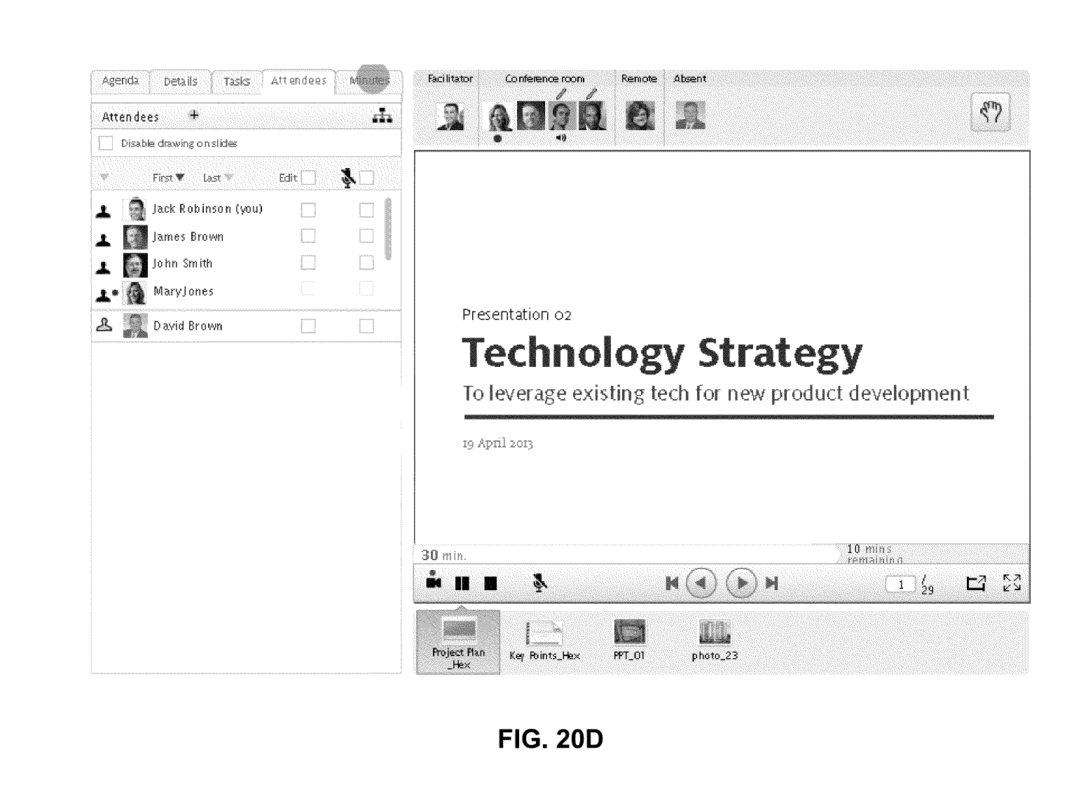

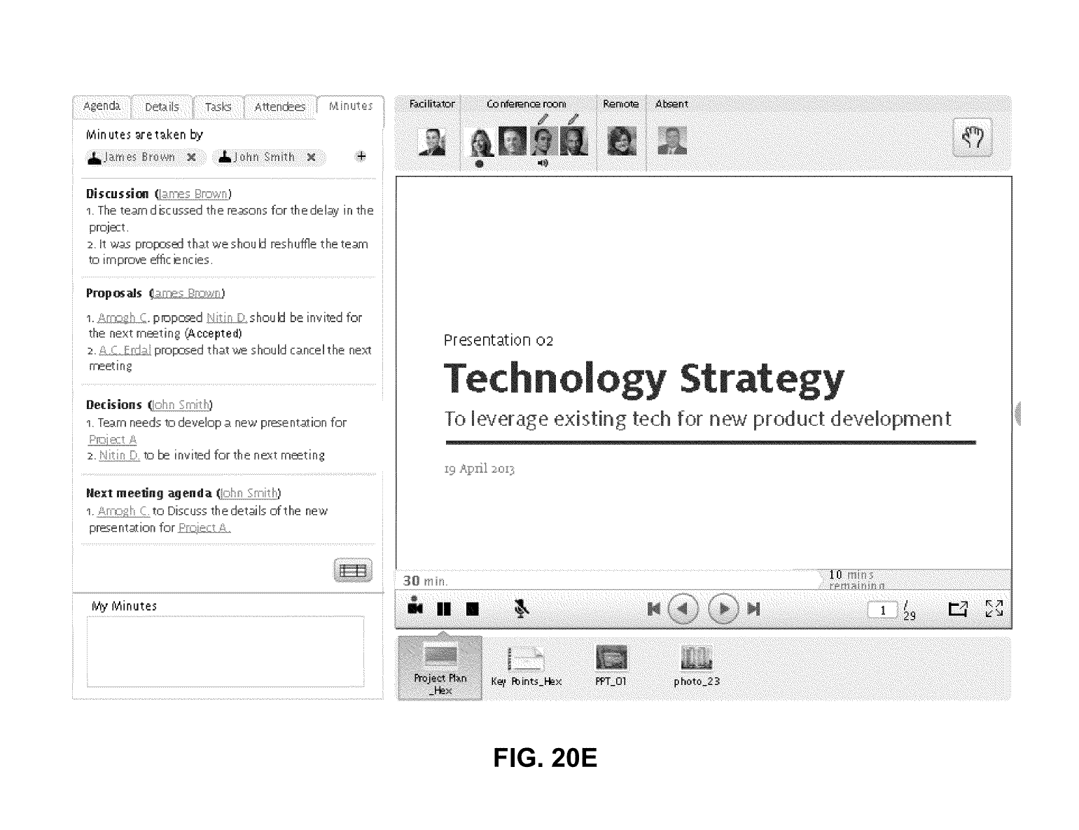

FIGS. 20A-20E are screenshots illustrating examples of graphical user interfaces of an integrated communication and collaboration platform according to some embodiments of the invention. The GUI pages may be generated and/or presented by interface module 507 of management server 501 and/or a client application of a client device such as client applications 508-509 of client devices 502-503 of FIG. 5. The user interface can be used by a user to host or participate a collaboration session (e.g., online conferencing) with other users. The collaboration session may be hosted by collaboration manager 513 of FIG. 5. Referring to FIG. 20A, in this example, a meeting or conferencing organizer or facilitator can host a collaboration session with other participants.

According to one embodiment, the user interface includes a first display area or display panel 2001 to display metadata of the meeting and a second display area 3002 to display the content shared with other participants. First display area 2001 includes multiple tabs or pages including, but are not limited to, an agenda page, a detail page, a task page, an attendee page, and a minute page. The agenda page display all the agendas of the meeting. The detail page display the detailed information of the meeting. The task page lists the tasks associated with the meeting. The attendee page displays information of all the attendees associated with the meeting. The minute page displays the meeting minutes during the meeting.

In the main display area 2002, thumbnails of facilitator, attendees (both in the conference call or remote), and those absent are displayed in sub display area 2003, while the shared content or presentation is displayed in sub display area 2004 (which is visible to all attendees), and the presentation files are listed in sub display area 2005. The file that is currently presented in display area 2004 is highlighted in display area 2005. Any of the attendee can ask or answer a question or propose a suggestion by clicking button 2006. The organizer can allow or deny such a request by clicking its corresponding button.

In the examples as shown in FIG. 20A, the agenda page is displayed in display area 2001. The agenda page includes several sub display areas including, but are not limited to, meeting agenda items with presentation time line displayed, additional presenters, meeting minutes, and meeting polls. The presenter who is currently presenting the content in display area 2004 is highlighted or indicated by some other forms in the meeting agenda subpage. FIG. 20B shows a detail page of the meeting in display area 2001, including subject of the meeting, purpose of the meeting, and messages sent to everybody. FIG. 20C shows a task page of the display area 2001 including a list of tasks associated with the meeting. FIG. 20E shows a meeting minute page in display area 2001, including the discussion, proposals, decisions, and next meeting agenda.

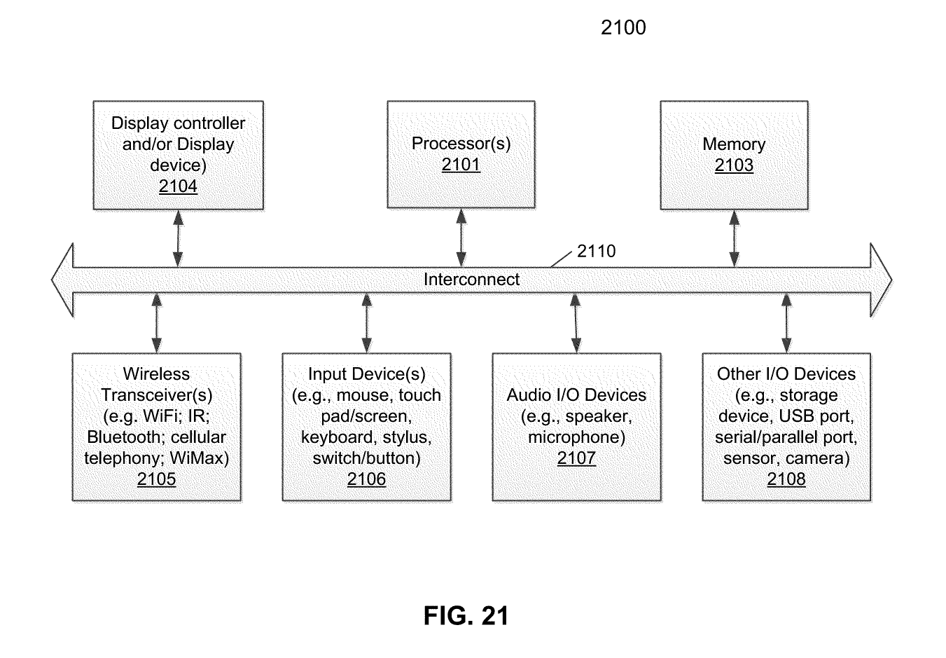

FIG. 21 is a block diagram illustrating an example of a data processing system which may be used with one embodiment of the invention. For example, system 2100 may represents any of data processing systems described above (e.g., server 501 and client devices 502-503 of FIG. 5) performing any of the processes or methods described above. System 2100 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 2100 is intended to show a high level view of many components of the computer system. However, it is to be understood that additional components may be present in certain implementations and furthermore, different arrangement of the components shown may occur in other implementations. System 2100 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof.

In one embodiment, system 2100 includes processor 2101, memory 2103, and devices 2105-2108 via a bus or an interconnect 2110. Processor 2101 may represent a single processor or multiple processors with a single processor core or multiple processor cores included therein. Processor 2101 may represent one or more general-purpose processors such as a microprocessor, a central processing unit (CPU), or the like. More particularly, processor 2101 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 2101 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 2101, which may be a low power multi-core processor socket such as an ultra-low voltage processor, may act as a main processing unit and central hub for communication with the various components of the system. Such processor can be implemented as a system on chip (SoC). In one embodiment, processor 2101 may be an Intel® Architecture Core™-based processor such as an i3, i5, i7 or another such processor available from Intel Corporation, Santa Clara, Calif. However, other low power processors such as available from Advanced Micro Devices, Inc. (AMD) of Sunnyvale, Calif., an ARM-based design from ARM Holdings, Ltd. or a MIPS-based design from MIPS Technologies, Inc. of Sunnyvale, Calif., or their licensees or adopters may instead be present in other embodiments.

Processor 2101 is configured to execute instructions for performing the operations and steps discussed herein. System 2100 further includes a graphics interface that communicates with graphics subsystem 2104, which may include a display controller and/or a display device.

Processor 2101 may communicate with memory 2103, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 that will offer extensions to LPDDR2 to increase bandwidth. As examples, 2/4/8 gigabytes (GB) of system memory may be present and can be coupled to processor 810 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

Memory 2103 may include one or more volatile storage (or memory) devices such as random access memory (RAM), dynamic RAM (DRAM), synchronous DRAM (SDRAM), static RAM (SRAM), or other types of storage devices. Memory 2103 may store information including sequences of instructions that are executed by processor 2101, or any other device. For example, executable code and/or data of a variety of operating systems, device drivers, firmware (e.g., input output basic system or BIOS), and/or applications can be loaded in memory 2103 and executed by processor 2101. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 2100 may further include IO devices such as devices 2105-2108, including wireless transceiver(s) 2105, input device(s) 2106, audio IO device(s) 2107, and other IO devices 2108. Wireless transceiver 2105 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof.

Input device(s) 2106 may include a mouse, a touch pad, a touch sensitive screen (which may be integrated with display device 2104), a pointer device such as a stylus, and/or a keyboard (e.g., physical keyboard or a virtual keyboard displayed as part of a touch sensitive screen). For example, input device 2106 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio 10 device 2107 may include a speaker and/or a microphone to facilitate voice-enabled functions, such as voice recognition, voice replication, digital recording, and/or telephony functions. Other optional devices 2108 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 2108 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 2110 via a sensor hub (not shown), while other devices such as a keyboard or thermal sensor may be controlled by an embedded controller (not shown), dependent upon the specific configuration or design of system 2100.

To provide for persistent storage of information such as data, applications, one or more operating systems and so forth, a mass storage (not shown) may also couple to processor 2101. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 2101, e.g., via a serial peripheral interface (SPI). This flash device may provide for non-volatile storage of system software, including a basic input/output software (BIOS) as well as other firmware of the system.

Note that while system 2100 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for processing actionable messages of an integrated communication and collaboration platform, the method comprising:
receiving a create command received from a first user of a device for composing a first actionable message specifying a first action to be performed by a second user as a recipient of the first actionable message;
in response to the create command, displaying a message composing user interface in a first display area of a display of the device, wherein displaying the message composing user interface comprises
displaying a first field within the message composing user interface to receive a due date of the first action, wherein the second user is required to complete performing the first action by the due date,
displaying a second field within the message composing user interface to receive a reply-by date of the first action, wherein the second user is required to respond to the first actionable message by the reply-by date to acknowledge receiving the first actionable message,
displaying a third field within the message composing user interface to receive a duration of the first action, wherein the third field is an optional field to allow the first user to provide an estimated amount of time required to complete the first action,
displaying a subject field to describe a subject matter of the first actionable message,
display a TO field to specify one or more recipients of the first actionable message, including an email address of the second user, and
displaying a message field to allow the first user to provide a description of the first actionable message;
in response to a send command received from the first user, transmitting the first actionable message to the second user over a network, the first actionable message including information specifying a first due date, a first reply-by date, and an optional first duration of the first action; and
displaying a first sidebar panel in a second display area of the display, the first sidebar panel including a first message identifier identifying the first actionable message that has been sent to the second user, wherein the first sidebar panel is configured to list all pending actions that are associated with the first user without listing regular email messages of the first users, wherein regular email messages are without an action attached therein.

2. The method of claim 1, wherein displaying the message composing user interface further comprises:
displaying a second sidebar panel in a third display area, while the first actionable message is concurrently displayed in the first display area;
displaying a contact window within the second sidebar panel having contacts of users associated with the first user; and
in response to a selection of a contact of the second user from the contact window of the second sidebar panel, automatically specifying an email address of the second user in the TO field of the first actionable message.

3. The method of claim 2, further comprising:
determining availability information of the second user based on calendar information associated with the second user;
displaying an available time slot window within the second sidebar panel, while the first actionable message is concurrently displayed within the first display area; and
displaying one or more time slots that are available for the second user based on the availability information of the second user in view of at least the first due date of the first action.

4. The method of claim 2, further comprising:
displaying a fourth field to allow the first user to specify a second action from which the first action depends, wherein the second action is associated with a second due date, a second reply-by date, and a second duration;
displaying a fifth field to allow the first user to attach one or more files to the first action; and
displaying a sixth field to allow the first user to provide a brief description of the first action.

5. The method of claim 4, further comprising:
displaying a first button to allow the first user to add a second action as a sub-action to the first action;
in response to an activation of the first button, displaying a sub-action composing user interface while displaying the first action in the first display area, including
displaying a seventh field to specify a second due date of the second action,
displaying an eighth field to specify a second reply-by date of the second action, and
displaying a ninth field to specify a second duration of the second action; and
linking the second action with the first action and storing linking information between the first action and the second action in a persistent storage device, such that the second action can be located from the first action, or vice versa.

6. The method of claim 1, further comprising:
determining whether the first action includes an event that requires multiple users to attend; and
in response to determining that the first action includes an event,
displaying within the first display area a must-attend field to specify an attendee who must attend the event,
displaying within the first display area a should-attend field to specify an attendee who should attend, and
displaying within the first display area a for-your-information (FYI) field to specify an attendee who only receives information of the first action without attending.

7. The method of claim 1, further comprising:
receiving a third actionable message from a third user over the network, the third actionable message including a third action having a third due date, a third reply-by date, and an optional third duration, wherein the third action is to be performed by the first user; and
in response to the third actionable message, displaying a third message identifier in the first sidebar panel identifying the third actionable message.

8. The method of claim 7, further comprising:
displaying the first message identifier in a first folder of the first sidebar panel, wherein the first folder is to list all pending actions issued by the first user; and
displaying the third message identifier in a second folder of the first sidebar panel, wherein the second folder is to list all pending actions received by the first user.

9. The method of claim 7, further comprising:
in response to a selection of the third message identifier in the first sidebar panel, displaying detailed information of the third actionable message in the first display area; and
displaying in the first display area the third due date, the third reply-by date, and the optional third duration of the third action.

10. The method of claim 9, further comprising:
displaying in the first display area a response field to allow the first user to respond to the first actionable message by selecting one of a plurality of predefined responses, the predefined responses including an accept response, a decline response, and a request-for-change (RFC) response; and
in response to a selection of one of the responses from the first user, transmitting a response message to the third user including the selected response received from the response field.

11. The method of claim 10, further comprising in response to an accept response of the third action received from the first user, displaying a calendar view in the first display area, the calendar view having calendar information associated with the first user in view of the third due date of the third action to allow the first user to schedule the third action.

12. The method of claim 11, further comprising:
displaying a 5-day button and a 7-day button within the calendar view to allow the first user to select different configurations of the calendar view;
in response to an activation of the 5-day button, displaying the calendar view in 5 days per calendar view; and
in response to an activation of the 7-day button, displaying the calendar view in 7 days per calendar view.

13. The method of claim 11, further comprising:
displaying a first scroll button and a second scroll button within the calendar view;
in response to an activation of the first scroll button, scrolling the entire calendar view; and
in response to an activation of the second scroll button, scrolling the calendar view by one day only.

14. The method of claim 11, further comprising:
displaying a second sidebar panel in a third display area, while the third actionable message is concurrently displayed in the first display area;
determining availability information of the first user based on calendar information associated with the first user; and
displaying a first available time slot window within the second sidebar panel, the first available time slot window having one or more time slots that are available for the first user based on the availability information of the first user in view of at least the third due date of the third action.

15. The method of claim 14, further comprising:
displaying an action owner window within the second sidebar panel, the action owner window listing one or more users to perform the third action, including the first user and a fourth user;
determining availability information of the fourth user based on calendar information associated with the fourth user; and
displaying a second available time slot window within the second sidebar panel, the second available time slot window having one or more time slots that are available for the fourth user based on the availability information of the fourth user in view of at least the third due date of the third action.

16. The method of claim 10, further comprising in response to an accept response of the third action received from the first user, automatically scheduling, without user intervention, the first action for the first user based on calendar information of the first user and a set of scheduling rules associated with the first user.

17. The method of claim 10, further comprising:
in response to an accept response of the third action received from the first user, displaying a list of a plurality of scheduling options, including a first-time-available option and an evenly-distributed option;
in response to a user selection of one of the scheduling options, automatically identifying based on calendar information of the first user one or more time slots that satisfy the selected scheduling option; and
scheduling the third action for the first user based on the identified one or more time slots.

18. The method of claim 10, further comprising:
receiving an RFC response from the first user via the response field of the third actionable message; and
in response to the RFC response, transmitting a fourth message to the third user, the fourth message including a proposal of one of modified third due date, modified third reply-by date, and modified third duration.

19. The method of claim 10, further comprising:
displaying a delegation option to allow the first user to delegate at least a portion of the third action to another user, in response to an accept response of the third action received from the first user; and
in response to a delegation command received from the first user via the delegation option, transmitting a fourth actionable message to a fourth user, the fourth actionable message including an action identifier identifying the third action to be performed by the fourth user, a fourth due date associated with the third action, a fourth reply-by date associated with the third action, and an optional fourth duration associated with the third action.

20. A non-transitory machine-readable medium having instructions stored therein, which when executed by a processor, cause the processor to perform operations of processing actionable messages of an integrated communication and collaboration platform, the operations comprising:
receiving a create command received from a first user of a device for composing a first actionable message specifying a first action to be performed by a second user as a recipient of the first actionable message;
in response to the create command, displaying a message composing user interface in a first display area of a display of the device, wherein displaying the message composing user interface comprises
displaying a first field within the message composing user interface to receive a due date of the first action, wherein the second user is required to complete performing the first action by the due date,
displaying a second field within the message composing user interface to receive a reply-by date of the first action, wherein the second user is required to respond to the first actionable message by the reply-by date to acknowledge receiving the first actionable message,
displaying a third field within the message composing user interface to receive a duration of the first action, wherein the third field is an optional field to allow the first user to provide an estimated amount of time required to complete the first action,
displaying a subject field to describe a subject matter of the first actionable message,
display a TO field to specify one or more recipients of the first actionable message, including an email address of the second user, and
displaying a message field to allow the first user to provide a description of the first actionable message;
in response to a send command received from the first user, transmitting the first actionable message to the second user over a network, the first actionable message including information specifying a first due date, a first reply-by date, and an optional first duration of the first action; and
displaying a first sidebar panel in a second display area of the display, the first sidebar panel including a first message identifier identifying the first actionable message that has been sent to the second user, wherein the first sidebar panel is configured to list all pending actions that are associated with the first user without listing regular email messages of the first users, wherein regular email messages are without an action attached therein.

21. The non-transitory machine-readable medium of claim 20, wherein displaying the message composing user interface further comprises:
displaying a second sidebar panel in a third display area, while the first actionable message is concurrently displayed in the first display area;
displaying a contact window within the second sidebar panel having contacts of users associated with the first user; and
in response to a selection of a contact of the second user from the contact window of the second sidebar panel, automatically specifying an email address of the second user in the TO field of the first actionable message.

22. The non-transitory machine-readable medium of claim 21, wherein the operations further comprise:
determining availability information of the second user based on calendar information associated with the second user;
displaying an available time slot window within the second sidebar panel, while the first actionable message is concurrently displayed within the first display area; and
displaying one or more time slots that are available for the second user based on the availability information of the second user in view of at least the first due date of the first action.

23. The non-transitory machine-readable medium of claim 21, wherein the operations further comprise:
displaying a fourth field to allow the first user to specify a second action from which the first action depends, wherein the second action is associated with a second due date, a second reply-by date, and a second duration;
displaying a fifth field to allow the first user to attach one or more files to the first action; and
displaying a sixth field to allow the first user to provide a brief description of the first action.

24. The non-transitory machine-readable medium of claim 23, wherein the operations further comprise:
displaying a first button to allow the first user to add a second action as a sub-action to the first action;
in response to an activation of the first button, displaying a sub-action composing user interface while displaying the first action in the first display area, including
displaying a seventh field to specify a second due date of the second action,
displaying an eighth field to specify a second reply-by date of the second action, and
displaying a ninth field to specify a second duration of the second action; and
linking the second action with the first action and storing linking information between the first action and the second action in a persistent storage device, such that the second action can be located from the first action, or vice versa.

25. The non-transitory machine-readable medium of claim 20, wherein the operations further comprise:
determining whether the first action includes an event that requires multiple users to attend; and
in response to determining that the first action includes an event,
displaying within the first display area a must-attend field to specify an attendee who must attend the event,
displaying within the first display area a should-attend field to specify an attendee who should attend, and
displaying within the first display area a for-your-information (FYI) field to specify an attendee who only receives information of the first action without attending.

26. The non-transitory machine-readable medium of claim 20, wherein the operations further comprise:
receiving a third actionable message from a third user over the network, the third actionable message including a third action having a third due date, a third reply-by date, and an optional third duration, wherein the third action is to be performed by the first user; and
in response to the third actionable message, displaying a third message identifier in the first sidebar panel identifying the third actionable message.

27. A data processing system, comprising:
a processor;
a display controller; and
a memory for storing instructions, which when executed from the memory by the processor, cause the processor to perform operations, the operations including
receiving a create command received from a first user for composing a first actionable message specifying a first action to be performed by a second user as a recipient of the first actionable message;
in response to the create command, displaying a message composing user interface in a first display area of a display controlled by the display controller, wherein displaying the message composing user interface comprises
displaying a first field within the message composing user interface to receive a due date of the first action, wherein the second user is required to complete performing the first action by the due date,
displaying a second field within the message composing user interface to receive a reply-by date of the first action, wherein the second user is required to respond to the first actionable message by the reply-by date to acknowledge receiving the first actionable message by the second user,
displaying a third field within the message composing user interface to receive a duration of the first action, wherein the third field is an optional field to allow the first user to provide an estimated amount of time required to complete the first action,
displaying a subject field to describe a subject matter of the first actionable message,
display a TO field to specify one or more recipients of the first actionable message, including an email address of the second user, and
displaying a message field to allow the first user to provide a description of the first actionable message;
in response to a send command received from the first user, transmitting the first actionable message to the second user over a network, the first actionable message including information specifying a first due date, a first reply-by date, and an optional first duration of the first action; and
displaying a first sidebar panel in a second display area, the first sidebar panel including a first message identifier identifying the first actionable message that has been sent to the second user, wherein the first sidebar panel is configured to list all pending actions that are associated with the first user without listing regular email messages of the first users, wherein regular email messages are without an action attached therein.

28. The system of claim 27, wherein displaying the message composing user interface further comprises:
displaying a second sidebar panel in a third display area, while the first actionable message is concurrently displayed in the first display area;
displaying a contact window within the second sidebar panel having contacts of users associated with the first user; and
in response to a selection of a contact of the second user from the contact window of the second sidebar panel, automatically specifying an email address of the second user in the TO field of the first actionable message.
